(19) United States
(12) Patent Application Publication
(10) Pub. No.: US 2026/0127192 A1
(43) Pub. Date: May 7, 2026

(54) DOMAIN-SPECIFIC RETRIEVAL LANGUAGE MODELS

(71) Applicant: NVIDIA Corporation, Santa Clara, CA (US)

(72) Inventor: Jiaheng Huang, Shenzhen (CN)

(73) Assignee: NVIDIA Corporation, Santa Clara, CA (US)

(21) Appl. No.: 18/949,371

(22) Filed: Nov. 15, 2024

(30) Foreign Application Priority Data
Nov. 1, 2024 (WO) PCT/CN2024/129231

(51) Int. Cl. G06F 16/25; G06F 16/242

(52) U.S. Cl. CPC G06F 16/254; G06F 16/243

(57) ABSTRACT

Various examples, systems, and methods are disclosed relating to domain-specific document retrieval that incorporates custom vocabulary integration and embedding model updates. A computing system can extract multiple segments from a collection of documents and generate queries that correspond to at least one segment. The computing system can identify terms that satisfy a uniqueness criterion and input the terms into a tokenizer to create a vocabulary dataset. The vocabulary dataset, the document segments, and the queries can be used to update an embedding model to support retrieval and semantic alignment within private documents.

### CROSS-REFERENCE TO RELATED APPLICATIONS

The present application claims priority to International Application No. PCT/CN2024/129231, filed Nov. 1, 2024, the disclosure of which is incorporated herein by reference in its entirety.

### BACKGROUND

Improving the accuracy and performance of document retrieval in text-based information retrieval systems presents challenges. Some traditional methods rely on generic text retrieval models without support for specialized vocabularies or internal document terminology, leading to inefficiencies and limited retrieval performance in private environments. This approach can result in inadequate retrieval accuracy. Current systems are not configured and/or trained to identify associations between private terms and relevant document content, resulting in inconsistent query responses when processing domain-specific language. Additionally, conventional methods rely on static, pre-trained tokenizers with vocabulary limited to publicly available terms, resulting in inefficiencies and degraded retrieval performance due to lack of recognition of private terminology. This approach can lead to redundant processing and failure to process document-specific terms effectively. Current methods are inadequate for handling terminology updates over time, which increases the complexity of maintaining retrieval relevance across evolving document collections. Challenges in implementing neural networks for embedding-based retrieval models create inefficiencies, affecting the accuracy and computational efficiency of text retrieval in domain-specific environments.

### SUMMARY

Implementations of the present disclosure relate to systems and methods for improving text retrieval in document collections using embedding models trained with domain-specific vocabularies. Systems and methods are disclosed that can use machine learning models, such as large language models (LLMs), combined with automated term extraction and query generation to improve retrieval accuracy across private documents. For example, systems and methods in accordance with the present disclosure can extract domain-specific terms from documents and utilize the terms to generate representative queries. This technical solution can output vector embeddings that capture semantic relationships between private terms, aligning retrieval outputs with the internal document vocabulary. Additionally, the systems and methods can update retrieval criteria based at least on parameters such as term frequency, relevance, or other probabilistic measures, improving retrieval alignment with private vocabularies. By updating embeddings to include newly identified terms based on these parameters, the systems and methods improve retrieval performance without extensive manual intervention. This update allows the retrieval model to maintain accuracy and efficiency across updating private document collections.

Some implementations relate to one or more processors including processing circuitry. The processing circuitry input, to a tokenizer, one or more terms that satisfy a uniqueness criterion to cause the tokenizer to tokenize the one or more terms into a vocabulary dataset. In some implementations, the one or more terms corresponding with a domain and are extracted from a plurality of documents. The processing circuitry extract, from the plurality of documents, a plurality of portions of the plurality of documents including the one or more terms corresponding with the domain. The processing circuitry generate, based at least on the plurality of portions, a plurality of queries corresponding to the plurality of portions. The processing circuitry update an embedding model based at least on the plurality of queries, plurality of portions, and the vocabulary dataset.

In some implementations, the plurality of portions of the plurality of documents are extracted by segmenting the plurality of documents based on at least one marker to segment content of the plurality of documents into the plurality of portions. In some implementations, the plurality of queries corresponding to the plurality of portions are generated by an large language model (LLM) trained to generate the plurality of queries based on content and context of the extracted plurality of portions. In some implementations, the content includes textual information in the plurality of portions. In some implementations, the context includes an association of the plurality of queries with the plurality of portions.

In some implementations, the generation of the plurality of queries includes prompting the LLM with a plurality of instructions based on the content and context of the plurality of portions and corresponding with at least one parameter. In some implementations, the one or more terms of the plurality of documents are extracted by an LLM trained to identify a plurality of segments of data based on the uniqueness criterion. In some implementations, the extraction of the one or more terms includes prompting the LLM with a plurality of instructions to identify a plurality of terms in the plurality of documents and corresponding with the uniqueness criterion.

In some implementations, the uniqueness criterion includes a plurality of frequencies of the one or more terms being below a threshold frequency in a vocabulary of the tokenizer. In some implementations, the threshold frequency corresponds to a frequency of occurrence or a frequency of co-occurrence. In some implementations, the threshold frequency is set based on a plurality of occurrences of a plurality of domain-specific terms within the plurality of documents. In some implementations, the embedding model includes a transformer model trained to convert a plurality of textual inputs into a plurality of continuous vector representations based on processing a plurality of tokens through a plurality of multi-layer attention mechanisms to encode a plurality of semantic relationships between the one or more terms.

Some implementations relate to a system. The system can include one or more processors to execute operations including extract, from a plurality of documents, a plurality of portions of the plurality of documents including one or more terms corresponding with a domain. The system can include one or more processors to execute operations including generate, based at least on the plurality of portions, a plurality of queries corresponding to the plurality of portions. The system can include one or more processors to execute operations including input, to a tokenizer, the one or more terms that satisfy a uniqueness criterion to cause the tokenizer to tokenize the one or more terms into a vocabulary dataset. In some implementations, the one or more terms are extracted from the plurality of documents. The system can include one or more processors to execute operations including update an embedding model based at least on the plurality of queries, the plurality of portions, and the vocabulary dataset.

In some implementations, the plurality of portions of the plurality of documents are extracted by segmenting the plurality of documents based on at least one marker to segment content of the plurality of documents into the plurality of portions. In some implementations, the plurality of queries corresponding to the plurality of portions are generated by an large language model (LLM) trained to generate the plurality of queries based on content and context of the extracted plurality of portions. In some implementations, the content includes textual information in the plurality of portions. In some implementations, the context includes an association of the plurality of queries with the plurality of portions.

In some implementations, the generation of the plurality of queries includes prompting the LLM with a plurality of instructions based on the content and context of the plurality of portions and corresponding with at least one parameter. In some implementations, the one or more terms of the plurality of documents are extracted by an LLM trained to identify a plurality of segments of data based on the uniqueness criterion. In some implementations, the extraction of the one or more terms includes prompting the LLM with a plurality of instructions to identify a plurality of terms in the plurality of documents and corresponding with the uniqueness criterion. In some implementations, the uniqueness criterion includes a plurality of frequencies of the one or more terms being below a threshold frequency in a vocabulary of the tokenizer.

Some implementations relate to a method. The method includes inputting, using one or more processors, one or more terms that satisfy a uniqueness criterion to cause the one or more processors to tokenize the one or more terms into a vocabulary dataset. In some implementations, the one or more terms corresponding with a domain and extracted from a plurality of documents. The method includes extracting, using the one or more processors from the plurality of documents, a plurality of portions of the plurality of documents including one or more terms corresponding with a domain. The method includes generating, using the one or more processors based at least on the plurality of portions, a plurality of queries corresponding to the plurality of portions. The method includes updating, using the one or more processors, an embedding model based at least on the plurality of queries, the plurality of portions, and the vocabulary dataset.

The processors, systems, and/or methods described herein can be implemented by or included in at least one a system. The system can include a system implementing one or more large language models (LLMs). The system can include a system implementing one or more small language models (SLMs). The system can include a system implementing one or more vision language models (VLMs). The system can include a system for generating synthetic data. The system can include a system for generating synthetic data using AI. The system can include a control system for an autonomous or semi-autonomous machine. The system can include a perception system for an autonomous or semi-autonomous machine. The system can include a system for performing simulation operations. The system can include a system for performing digital twin operations. The system can include a system for performing light transport simulation. The system can include a system for performing collaborative content creation for 3D assets. The system can include a system for performing deep learning operations. The system can include a system for performing remote operations. The system can include a system for performing real-time streaming. The system can include a system for generating or presenting one or more of augmented reality content, virtual reality content, or mixed reality content. The system can include a system implemented using an edge device. The system can include a system implemented using a robot. The system can include a system for performing conversational AI operations. The system can include a system implementing one or more multi-model language models. The system can include a system incorporating one or more virtual machines (VMs). The system can include a system implemented at least partially in a data center. The system can include a system implemented at least partially using cloud computing resources.

### BRIEF DESCRIPTION OF THE DRAWINGS

The present systems and methods for improving document retrieval accuracy and efficiency in embedding-based text retrieval pipelines are described in detail below with reference to the attached drawing figures, wherein:

FIG. 1 is a block diagram of an example of a system, in accordance with some implementations of the present disclosure;

FIG. 2 is a flow diagram of an example of a method for embedding-based document retrieval in a text retrieval pipeline, in accordance with some implementations of the present disclosure;

FIG. 3A is a block diagram of an example generative language model system for use in implementing at least some implementations of the present disclosure;

FIG. 3B is a block diagram of an example generative language model that includes a transformer encoder-decoder for use in implementing at least some implementations of the present disclosure;

FIG. 3C is a block diagram of an example generative language model that includes a decoder-only transformer architecture for use in implementing at least some implementations of the present disclosure;

FIG. 4 is a block diagram of an example computing device for use in implementing at least some implementations of the present disclosure; and

FIG. 5 is a block diagram of an example data center for use in implementing at least some implementations of the present disclosure.

### DETAILED DESCRIPTION

This disclosure relates to systems and methods for domain-specific retrieval language models, such as retrieval models that can be used for document retrieval in specific and/or private domains, such as domains that relate to unique or private vocabularies (e.g., proprietary technical terms, domain-specific acronyms, industry-specific jargon, internal project codes, confidential product names, and/or any specialized terminology). Some large language model (LLM) technologies, such as embedding models, can perform well on general texts, such as to retrieve data from text information and/or generate responses to queries for text information. However, such models can fail to accurately retrieve data where directed to operate on documents that have vocabulary outside of general or publicly available data sources. For example, retrieval-based approaches can chunk documents from which to retrieve data (e.g., form subportions of the documents), and can embed the chunks. A query for a user can be embedded, and the comparisons and/or similarities amongst the embedded query and embedded chunks can be evaluated to select documents or chunks thereof to retrieve. However, a tokenizer used by the models may not have training with respect to semantics or syntax of terms in the outside vocabulary (e.g., technical jargon, private terms), which can lead to degraded retrieval performance.

Systems and methods in accordance with the present disclosure can apply a language model to domain-specific documents to detect terms in the documents that satisfy a uniqueness criteria, such as not being present in a predetermined vocabulary of the language model and/or be present below a threshold frequency. The system can input the detected terms as tokens to a tokenizer and/or embedding model. The system can generate a training dataset from the domain-specific documents, such as by performing chunking of the documents, and causing a language model to generate queries (e.g., questions) corresponding to chunks of documents. The system can determine training data samples that include a given chunk of a document and a corresponding query generated for the given chunk. The system can update (e.g., train, fine-tune, perform transfer learning on, configure) embedding model based at least on the training data samples.

For example, the system can input, to a tokenizer, one or more terms that satisfy a uniqueness criteria, the one or more terms extracted from a plurality of documents. The system can also extract, from the plurality of documents, a plurality of portions of the plurality of documents (e.g., text segments containing domain-specific terms). That is, the system can use a large language model (LLM) to identify and extract the portions based on the terms that meet the uniqueness criteria (e.g., terms below a threshold frequency in vocabularies). The system can generate, based at least on the plurality of portions, a plurality of queries corresponding to the plurality of portions (e.g., generating queries customized to private terms). Based on generating the plurality of queries, the system can update an embedding model using the tokenizer and based at least on the plurality of queries and the plurality of portions. Thus, the system can improve retrieval performance by using domain-specific vocabularies, improving the retrieval accuracy of transformer-based models.

In some implementations, the system can use an LLM trained to identify a plurality of segments of data based on the uniqueness criterion (e.g., domain-specific). That is, the LLM can be trained to extract segments of the documents that correspond to domain-specific applications or documents and satisfy predefined criteria. For example, these portions can include technical terms or private vocabulary not commonly found in general language datasets. The system can also generate a plurality of queries corresponding to the extracted portions, where at least one portion of the plurality of portions can satisfy the uniqueness criterion. For example, the LLM can be used to generate the plurality of queries based on the content and context of the extracted plurality of portions (e.g., relationship of terms within the extracted data).

In some implementations, the textual information in the plurality of portions can include a plurality of domain-specific terms that satisfy the uniqueness criterion (e.g., relevant to internal terms). That is, the context can include an association of the plurality of queries with the plurality of portions based on a frequency of occurrence or a frequency of co-occurrence of the one or more terms that satisfy the uniqueness criterion within the plurality of portions (e.g., how often terms appear together). Additionally, the system can also refine the uniqueness criterion by updating (or setting) the criteria based on a plurality of frequencies of the one or more terms being below a threshold frequency in a vocabulary of the tokenizer (e.g., technical terms), where the threshold frequency can be adjusted according to the occurrences of the domain-specific terms within the documents. For example, the system can adjust the threshold frequency dynamically to improve retrieval outcomes.

The system can also prompt an LLM with a plurality of instructions to identify a plurality of terms in the plurality of documents corresponding to at least one parameter (e.g., domain-specific terms and/or topics). That is, the system can configure the LLM to respond to specific prompts designed to highlight terms relevant to the domain context. For example, the system can provide parameters such as domain-specific keywords or contexts to direct the LLM in identifying terms that improve the retrieval understanding of specialized vocabularies. Additionally, the embedding model can include a transformer model trained to convert a plurality of textual inputs into a plurality of continuous vector representations (e.g., vector embeddings representing relationships between technical terms). For example, a plurality of tokens can be processed through multi-layer attention mechanisms to encode a plurality of semantic relationships between the one or more terms.

In some examples, the machine learning model(s) (e.g., deep neural networks, language models, LLMs, VLMs, multi-modal language models, perception models, tracking models, fusion models, transformer models, diffusion models, encoder-only models, decoder-only models, encoder-decoder models, neural rendering field (NERF) models, diarization models, transcription models, etc.) described herein can be packaged as a microservice—such an inference microservice (e.g., NVIDIA NIMs)—which can include a container (e.g., an operating system (OS)-level virtualization package) that can include an application programming interface (API) layer, a server layer, a runtime layer, and/or a model “engine.” For example, the inference microservice can include the container itself and the model(s) (e.g., weights and biases). In some instances, such as where the machine learning model(s) is small enough (e.g., has a small enough number of parameters), the model(s) can be included within the container itself. In other examples—such as where the model(s) is large—the model(s) can be hosted/stored in the cloud (e.g., in a data center) and/or can be hosted on-premises and/or at the edge (e.g., on a local server or computing device, but outside of the container). In such implementations, the model(s) can be accessible via one or more APIs—such as REST APIs. As such, and in some implementations, the machine learning model(s) described herein can be deployed as an inference microservice to accelerate deployment of a model(s) on any cloud, data center, or edge computing system, while ensuring the data is secure. For example, the inference microservice can include one or more APIs, a pre-configured container for simplified deployment, an optimized inference engine (e.g., built using a standardized AI model deployment an execution software, such as NVIDIA's Triton Inference Server, and/or one or more APIs for high performance deep learning inference, which can include an inference runtime and model optimizations that deliver low latency and high throughput for production applications—such as NVIDIA's TensorRT), and/or enterprise management data for telemetry (e.g., including identity, metrics, health checks, and/or monitoring). The machine learning model(s) described herein can be included as part of the microservice along with an accelerated infrastructure with the ability to deploy with a single command and/or orchestrate and auto-scale with a container orchestration system on accelerated infrastructure (e.g., on a single device up to data center scale). As such, the inference microservice can include the machine learning model(s) (e.g., that has been optimized for high performance inference), an inference runtime software to execute the machine learning model(s) and provide outputs/responses to inputs (e.g., user queries, prompts, etc.), and enterprise management software to provide health checks, identity, and/or other monitoring. In some implementations, the inference microservice can include software to perform in-place replacement and/or updating to the machine learning model(s). When replacing or updating, the software that performs the replacement/updating can maintain user configurations of the inference runtime software and enterprise management software.

In some implementations, the system and methods described herein can be deployed in a talking or smart kiosk application. That is, the system can retrieve domain-specific information to generate responses or instructions, supporting interactive, context-aware user interactions in environments like retail or customer service. For example, a kiosk, tablet, smart display, or other device can include one or more onboard processors (e.g., CPUs, GPUs, deep learning accelerators, SoCs) and memory and/or storage (e.g., for storing the model, the image database, etc.). In some implementations, the kiosk/tablet/display can communicate (e.g., using one or more network interface cards (NICs) and/or data processing units (DPUs)) with one or more locally hosted servers/computing devices and/or with one or more remotely located servers/computing devices (e.g., in one or more data centers). In such examples, the kiosk can communicate with the machine learning model(s) (e.g., language model, LLM, VLM, MMLM, diffusion model, transformer model, NeRF, DNN, etc.) hosted on the local and/or remote servers using one or more APIs—such as, without limitation, REST APIs.

In one or more implementations, the system and methods described herein can be deployed in a gaming application. That is, the system can manage retrieval of domain-specific content, such as in-game terminology or custom player actions, by integrating private vocabulary into an embedding model. For example, a gaming console, PC, tablet, or other gaming device can include one or more onboard and/or remote processors (e.g., CPUs, GPUs, deep learning accelerators, SoCs) and memory and/or storage (e.g., for storing the game model, game assets, player data, etc.). These devices can use one or more machine learning models (e.g., diffusion models, transformer models, neural rendering field (NeRF) models, language models (e.g., LLMs, VLMs, MMLMs, etc.), DNNs, etc.) to enhance gameplay, generate real-time dynamic content, and personalize user experiences based on in-game behavior or pre-stored player profiles. In some implementations, the system can be deployed in a cloud gaming environment (e.g., NVIDIA's GeFORCE NOW). In such cases, a client device (e.g., a smart display, tablet, or gaming controller) can be used to interact with the game, while the machine learning model(s) and/or visual rendering can occur on one or more remotely located servers/computing devices (e.g., in one or more data centers). The language model, AI processing, and rendering described herein can operate in the cloud, processing player inputs received from an end-user device(s) (e.g., based on controller, keyboard, mouse, joystick, AR/VR/MR/etc. inputs), generating appropriate in-game responses, rendering the content, and sending or transmitting the content to the end-user device(s). During receiving and/or sending the data to and from the end-user or edge device(s), one or more data processing units (DPUs) and/or network interface cards (NICs) can be used.

In some implementations, the system and methods described herein can be deployed in a video conferencing application. That is, the system can retrieve context-specific vocabulary, such as terms unique to the platform or meeting context. For example, a video conferencing device, such as a dedicated conferencing unit, computer, tablet, and/or smartphone, can include one or more onboard processors (e.g., CPUs, GPUs, deep learning accelerators, SoCs) and memory and/or storage (e.g., for storing the video, audio, or other communication-related data). The system can use the machine learning model(s) (e.g., diffusion models, transformer models, neural rendering field (NeRF) models, language models (e.g., LLMs, VLMs, MMLMs, etc.)) to enhance video conferencing functionality, including real-time or near real-time transcription, diarization, language translation, automatic speech recognition (ASR), and/or background noise reduction. In one or more implementations, the system can enable users to interact with the video conferencing platform using natural language inputs. For example, users can issue voice commands to schedule, join, or leave meetings, or to manage participants and screen sharing. During receiving and/or sending the data to and from the end-user or edge device(s), one or more data processing units (DPUs) and/or network interface cards (NICs) can be used.

In some implementations, the system and methods described herein can be deployed in a robotics application. That is, the system can retrieve and process task-specific terminology. For example, a robot or robotic system can include one or more onboard processors (e.g., CPUs, GPUs, hardware-based deep learning accelerators (DLAs), hardware-based programmable vision accelerators (PVAs)-which can include one or more vector processing units (VPUs), direct memory access (DMA) systems, and/or pixel processing engines (PPEs), hardware-based optical flow accelerators (OFAs), SoCs, etc.) and memory and/or storage (e.g., for storing control algorithms, sensor data, and one or more machine learning models). The robotic system can use these processors to execute one or more machine learning models (e.g., language models) that allow it to perform complex tasks autonomously or semi-autonomously, such as interacting with and/or manipulating static and/or dynamic objects, or navigating environments using sensors such as cameras, LiDAR, RADAR, ultrasonic sensors, and more. The system can use sensor fusion techniques to combine data from multiple sensors (e.g., cameras, infrared, LiDAR, RADAR, accelerometers) to create a comprehensive model of the robot's surroundings. This data can be processed locally on the robot or sent to remote servers for more computationally intensive tasks, such as 3D mapping or SLAM (Simultaneous Localization and Mapping). In one or more implementations, data from individual robots (e.g., sensor data, task status, or environmental conditions) can be uploaded to the cloud, where centralized AI models can analyze and distribute optimized commands to an entire fleet. In some implementations, the machine learning model(s) (e.g., language models, VLMs, LLMs, MMLMs, diffusion models, NeRF models, DNNs, etc.) described herein can be used to allow the robot to perceive and reason about the environment and/or communicate with one or more other robots and/or persons in an environment. In some implementations, the robot can communicate (e.g., using one or more network interface cards (NICs) and/or data processing units (DPUs)) with one or more locally hosted servers/computing devices and/or with one or more remotely located servers/computing devices (e.g., in one or more data centers).

In some implementations, the system and methods described herein can be deployed in an in-vehicle infotainment (IVI) system or in-cabin experience (IX) application. That is, the system can retrieve and present customized content or navigation commands. For example, the infotainment system within a vehicle (e.g., cars, trucks, drones, construction equipment, robots, semi-autonomous vehicles, or autonomous vehicles) can include one or more onboard processors (e.g., CPUs, GPUs, hardware-based deep learning accelerators (DLAs), hardware-based programmable vision accelerators (PVAs)—which can include one or more vector processing units (VPUs), direct memory access (DMA) systems, and/or pixel processing engines (PPEs), hardware-based optical flow accelerators (OFAs), SoCs, etc.) and memory and/or storage (e.g., for storing control algorithms, sensor data, and one or more machine learning models), and memory and/or storage (e.g., for storing entertainment content, navigation data, and user preferences). The system can use these processors to execute one or more machine learning models (e.g., language models) to enable features such as voice control, personalized media recommendations, dynamic navigation, and real-time communication with other services through network connectivity. The in-vehicle infotainment system can also use natural language processing (NLP) models to enable voice-based interaction. The one or more machine learning models can be stored locally or accessed through one or more APIs that connect to cloud services, enabling the system to process requests in real time or near real-time.

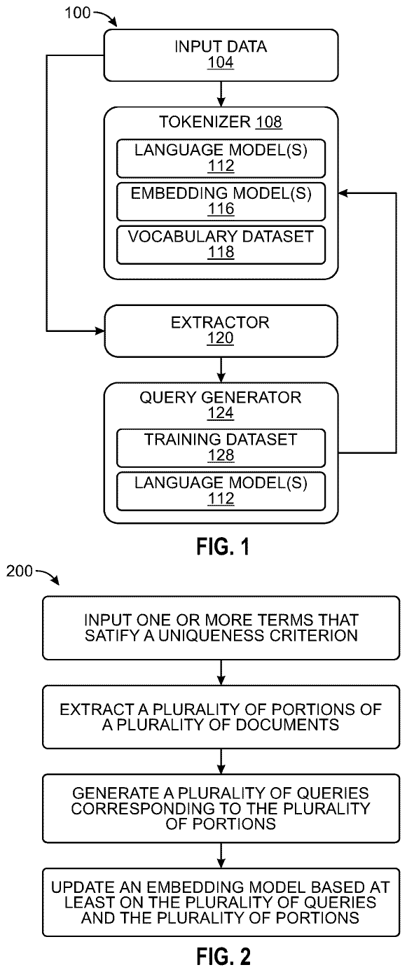

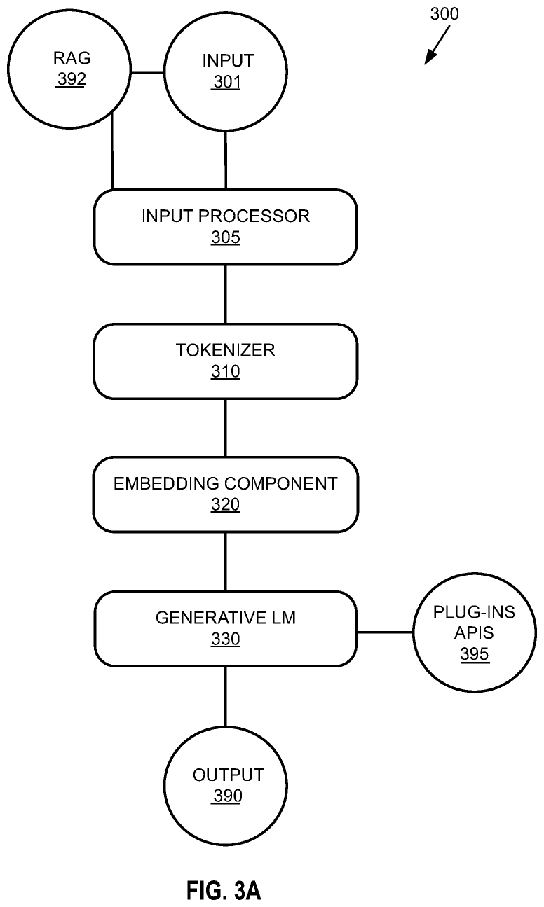

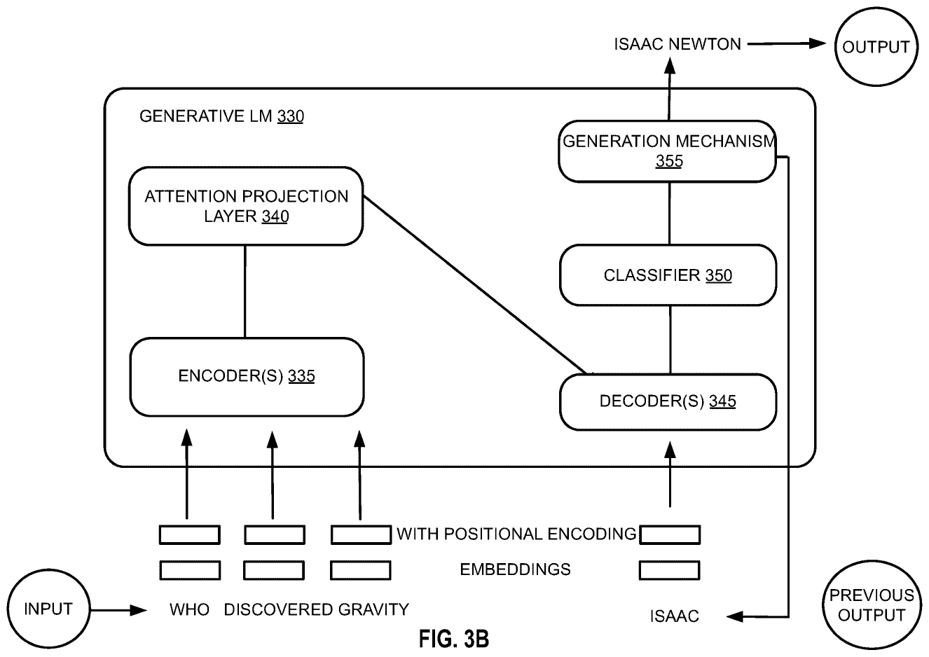

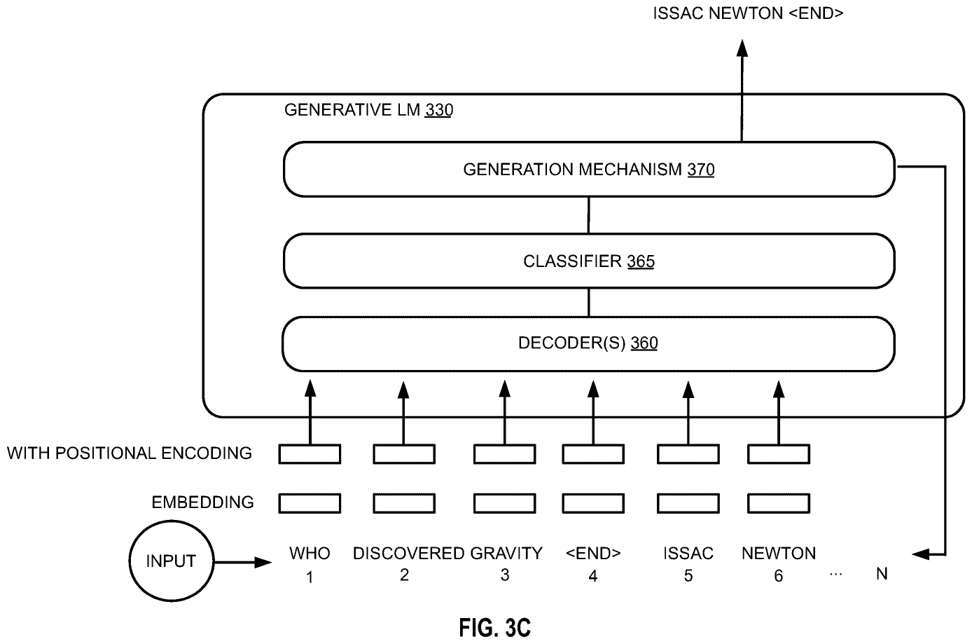

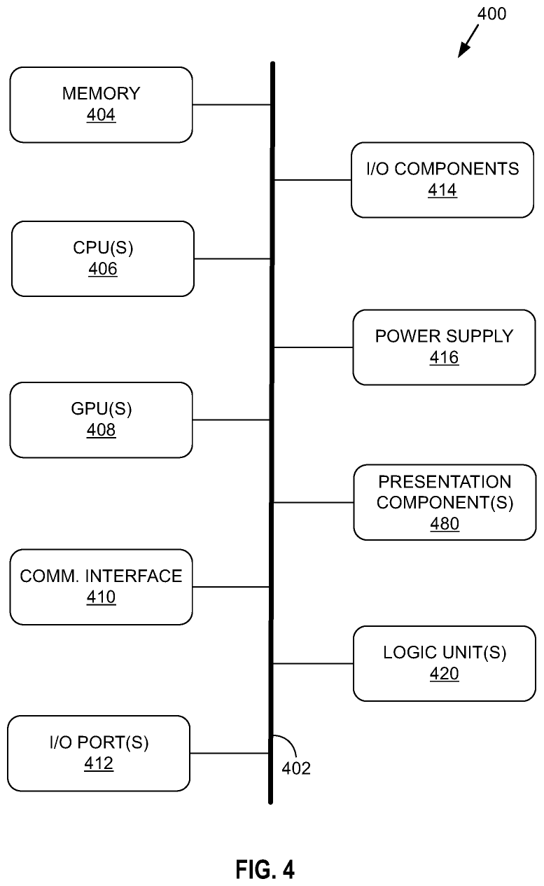

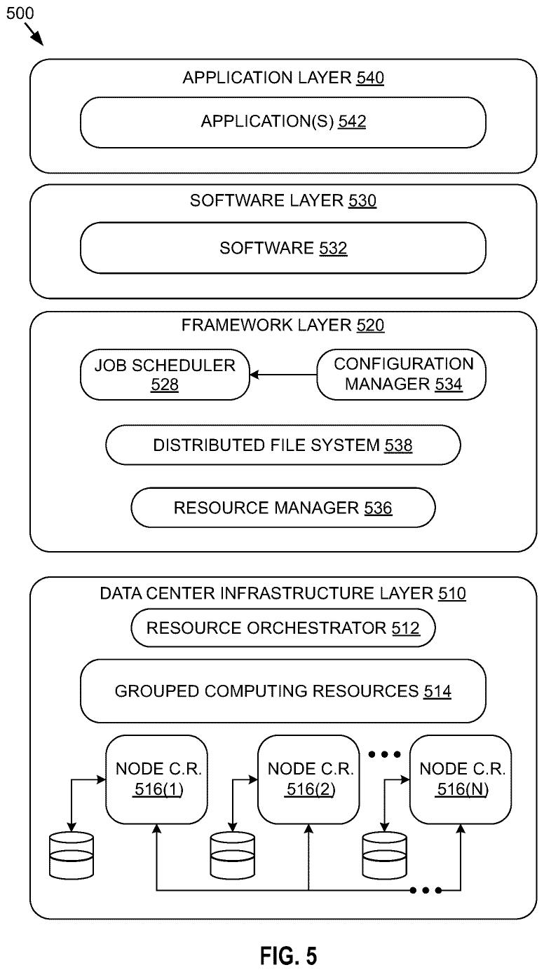

With reference to FIG. 1, FIG. 1 is an example block diagram of a system 100, in accordance with some implementations of the present disclosure. It should be understood that this and other arrangements described herein are set forth only as examples. Other arrangements and elements (e.g., machines, interfaces, functions, orders, groupings of functions, etc.) can be used in addition to or instead of those shown, and some elements can be omitted altogether. Further, many of the elements described herein are functional entities that can be implemented as discrete or distributed components or in conjunction with other components, and in any combination and location. Various functions described herein as being performed by entities can be carried out by hardware, firmware, and/or software. For example, various functions can be carried out by a processor executing instructions stored in memory. In some implementations, the systems, methods, and processes described herein can be executed using similar components, features, and/or functionality to those of example generative language model system 300 of FIG. 3A, example generative language model (LM) 330 of FIGS. 3B-3C, example computing device 400 of FIG. 4, and/or example data center 500 of FIG. 5.

With reference to FIG. 1, FIG. 1 is an example block diagram of a system 100, in accordance with some implementations of the present disclosure. It should be understood that this and other arrangements described herein are set forth only as examples. Other arrangements and elements (e.g., machines, interfaces, functions, orders, groupings of functions, etc.) can be used in addition to or instead of those shown, and some elements can be omitted altogether. Further, many of the elements described herein are functional entities that can be implemented as discrete or distributed components or in conjunction with other components, and in any combination and location. Various functions described herein as being performed by entities can be carried out by hardware, firmware, and/or software. For example, various functions can be carried out by a processor executing instructions stored in memory. In some implementations, the systems, methods, and processes described herein can be executed using similar components, features, and/or functionality to those of example generative language model system 300 of FIG. 3A, example generative language model (LM) 330 of FIGS. 3B-3C, example computing device 400 of FIG. 4, and/or example data center 500 of FIG. 5.

The system 100 can implement at least a portion of an embedding-based text retrieval pipeline (referred to hereafter as a “retrieval pipeline”), such as a document retrieval pipeline, a query matching pipeline, or a semantic search pipeline. The system 100 can be used to process private terms and/or generate domain-specific embeddings by any of various systems described herein, including but not limited to internal document retrieval systems, customer support systems, knowledge management systems, research data indexing systems, enterprise search systems, compliance monitoring systems, and/or content recommendation systems.

Generally, the retrieval pipeline can include operations performed by the system 100. For example, the retrieval pipeline can include any one or more of a tokenization stage, an extraction stage, a query generation stage, and/or an embedding stage. At least one (e.g., each) stage of the retrieval pipeline includes one or more components of the system 100 that perform the functions described herein. In some implementations, one or more of the stages can be performed during the training of AI models. Additionally, one or more of the stages can be performed during the inference phase of the AI models.

The system 100 (e.g., implementing the retrieval pipeline) can input, to a tokenizer 108, one or more terms (e.g., extracted from a plurality of documents) that satisfy a uniqueness criterion to cause the tokenizer 108 to map, e.g., tokenize, the one or more terms into a vocabulary dataset 118. The tokenizer 108 can perform mapping by assigning unique identifiers to each term and structuring the terms according to positional indices within the vocabulary dataset 118. That is, to map terms, the tokenizer 108 can analyze at least one (e.g., each) placement and frequency of the term, determine the relevance of the term to the private context, and/or allocate a corresponding token ID for the at least one (e.g., each) term. For example, the tokenizer 108 can assign identifiers based on a frequency and positional relevance of the term (e.g., organizing the mapped terms in a format for retrieval).

In some implementations, tokenizer 108 can map terms to unique token IDs by analyzing term context, frequency, and/or domain relevance, creating structured data in vocabulary dataset 118. At least one token ID can be a reference point, allowing embedding model(s) 116 to retrieve terms directly. For example, private terms such as “TH500” can be assigned a single token ID, which embedding model(s) 116 can then recognize as a single unit rather than splitting it into characters (e.g., “T,” “H,” “5,” “0,” “0”). This mapping allows the embedding model(s) 116 to use the structured vocabulary dataset 118 to reference terms accurately, maintaining their original integrity without unintended tokenization errors. Additionally, tokenizer 108 can also store term metadata such as co-occurrence counts and positional indices. Mapping can include organizing terms by sequence patterns observed within documents, creating clusters that the embedding model(s) 116 can reference for more term recognition and vector encoding.

Additionally, the tokenizer 108 can apply one or more terms that satisfy a uniqueness criterion to tokenizer 108 as input to cause the tokenizer 108 to tokenize the one or more terms into a vocabulary dataset 118. In some implementations, implementing the retrieval pipeline can include the system 100 extracting (e.g., chunking), from the plurality of documents (e.g., input data 104), a plurality of portions of the plurality of documents. Additionally, implementing the retrieval pipeline can include the system 100 generating, based at least on the plurality of portions, a plurality of queries corresponding to the plurality of portions. Furthermore, the implementing the retrieval pipeline can include the system 100 updating (e.g., fine-tune, train) embedding model 116 based at least on the plurality of queries, the plurality of portions, and the vocabulary dataset. Thus, the retrieval pipeline can improve the relevance and efficiency of document retrieval across domain-specific collections and improve the accuracy of embedding models in representing private terminology, capturing semantic relationships within specialized vocabularies, and/or updating to changes in domain-specific language and/or terminology.

In some implementations, the tokenization stage can be the stage in the retrieval pipeline in which the system 100 can identify and segment text into tokens for further processing by downstream models (e.g., by embedding model(s) 116). The system 100 can include at least one tokenizer 108. The tokenizer 108 can input, to a tokenizer, one or more terms (e.g., extracted from input data 104 including a plurality of documents) that satisfy a uniqueness criterion to cause the tokenizer 108 to tokenize the one or more terms into a vocabulary dataset 118 (e.g., storing private terminology, domain-specific identifiers, unique technical terms, and/or product-specific acronyms).

In some implementations, the tokenizer 108 can tokenize the terms into one or more tokens (e.g., words, subwords, or characters). For example, the input data 104 can be documents containing technical descriptions such as [“System architecture of TH500 module,” “Thermal resistance testing for T239,” “Configuration guidelines for GPU T281”], and the tokenizer 108 can apply the inputs and/or one or more prompts to guide the language model(s) 112 (e.g., containing criterion) to identify private terms based on context. In this example, the prompt can be “Identify domain-specific terms related to system architecture and configurations that do not commonly appear in external datasets,” and the language model(s) 112 can process the input data 104 to extract terms relevant to the private vocabulary of the organization, company, entity, client, and/or user. Additionally, the tokenizer 108 can tokenize the output of the language model(s) 112 by assigning unique token IDs (e.g., 10123, 10234, 10345) to each identified term. For example, the tokenizer 108 can assign 10123 as a unique ID to “TH500.” In this example, the new tokens can be new_tokens=[“TH500”, “T239”, “T281”], where at least one (e.g., each) token can correspond to private terms identified in the vocabulary. In some implementations, the tokens can be stored in a vocabulary dataset 118.

In some implementations, the tokenizer 108 can perform tokenization by assigning unique token IDs to terms provided by the language model 112 after merging and removing duplicates. That is, the tokenizer 108 can store at least one (e.g., each) term along with its token ID in the vocabulary dataset 118. For example, if the vocabulary includes terms like “TH500” and “EC077,” the tokenizer 108 can assign at least one (e.g., each) token a token ID and store them in the vocabulary dataset 118. In some implementations, the tokenizer 108 can perform tokenization by splitting compound or unknown terms into subwords when they do not match existing vocabulary entries in vocabulary dataset 118. That is, the tokenizer 108 can apply subword tokenization (e.g., byte-pair encoding). For example, “GPUMod” can be split into “GPU” and “Mod” for granular representation. In some implementations, the tokenizer 108 can perform tokenization by processing terms as individual units. It should be understood that while various methods of tokenization have been described herein, various other tokenization methods or processes can be performed by tokenizer 108, such as, but not limited to, character-level tokenization (e.g., splitting text into individual characters) and/or sentence-level tokenization (e.g., dividing text based on sentence boundaries).

In some implementations, criterion and/or criteria can define what terms are domain-specific (e.g., not present in general vocabulary, present less than a threshold frequency, such as below 0.05% occurrence in standard documents, below 50 instances across corpora, and/or appearing infrequently in industry-standard vocabularies, and/or appearing primarily in private datasets). That is, the tokenizer 108 can filter and/or extract the terms from input data 104 (e.g., using the language model(s) 112), tokenize the private terminology (or terms), and/or store identified private terms into vocabulary dataset 118. The tokenizer 108 can perform the filtering and/or extracting by prompting at least one neural network with a context (e.g., “Please identify the domain-specific terms related to “chips” and “GPU” in the text above and provide the output in JSON format.”) and the input data 104 including text and/or other content (e.g., files (e.g., videos, PDFs, images), research documents, product manuals, engineering notes, project reports, and/or any private technical materials).

In some implementations, the tokenizer 108 can extract and/or identify the one or more terms based on at least the context and criterion at least one neural network (e.g., large language model (LLM), transformer model, recurrent neural network (RNN), support vector machine (SVM), and/or any domain-specific neural network model). That is, the tokenizer 108 can use language model 112 to generate terms (e.g., represented in a JSON format). For example, a term such as “TH500” can be identified by the language model 112 as a relevant domain-specific term for tokenization. The output (e.g., in a designated format or a default format, such as JSON) of the language model 112 can include these terms (e.g., private vocabulary) that can be tokenized (e.g., after merging and/or removing duplicates) to be stored in the vocabulary dataset 118. For example, private vocabulary can include internal product names and identifiers. In this example, private terms for a chip and/or graphics processing unit (GPU) can include “MODS”, “T264”, “T281”, “TH500”, “T239”, “T234”, “L4T”, “MP”, “NPI”, “351194”, and “Blackwell.”

The tokenizer 108 can include any one or more artificial intelligence models (e.g., machine learning models, supervised models, neural network models, deep neural network models), rules, heuristics, algorithms, functions, or various combinations thereof to perform operations including token identification and term extraction, such as filtering and categorizing domain-specific vocabulary. That is, language model 112 can be a neural network trained to generate terms (e.g., domain-specific) and/or vocabulary of documents. For example, the tokenizer 108 can prompt the language model(s) 112 to extract one or more terms with a plurality of instructions to identify (e.g., find, classify, retrieve) a plurality of terms in the input data 104 and corresponding with at least one parameter (e.g., criterion).

In some implementations, the tokenizer 108 can output a set of extracted terms (e.g., domain-specific vocabulary, unique identifiers, filtered private terms, and/or any context-relevant tokens). For example, the language model 112 can output terms related to internal systems and processes that match a specified uniqueness criterion (e.g., internal project codes, private software names, technical component identifiers, company-specific acronyms, and/or any customized hardware terms). For example, the language model 112 can output private technical terms specific to the product lines of a company. In some implementations, the tokenizer 108 can merge extracted terms and remove duplicates from the list of terms prior to tokenization. The tokenizer 108 can process the list generated from multiple documents, identifying identical or equivalent entries. For example, if the language model 112 outputs variations such as “EC077,” “EC-077,” and “EC 077,” the tokenizer 108 can consolidate these entries into a single representation.

In some implementations, the tokenizer 108 can generate a prompt that specifies the uniqueness criterion for identifying domain-specific terms within a document set. For example, the tokenizer 108 can generate a prompt such as, “Identify terms specific to internal systems that are unique to our organization and appear infrequently (e.g., less than 0.05% frequency or fewer than 10 occurrences per million words in external corpora),” guiding the language model 112 to facilitate extraction of specific vocabulary. In this example, the uniqueness criterion can be for terms with less than 0.05% frequency or fewer than 10 occurrences per million words in general language datasets (e.g., dictionary). In some implementations, the one or more terms can be provided to the tokenizer 108 to perform tokenization. Additionally, language model 112 can be the neural network trained to also generate queries corresponding to portions of documents (described in greater detail below with reference to query generator 124).

In some implementations, the tokenizer 108 can maintain, execute, train, and/or update one or more machine-learning models during the tokenization stage. In some implementations, the language model(s) 112 can include any type of neural network-based machine-learning models capable of processing large text corpora (e.g., extracting unique terminology) to refine vocabulary for domain-specific contexts. For example, the language model(s) 112 can be trained and/or updated to identify and recommend vocabulary additions, among other vocabulary refinement tasks. The language model(s) 112 can be or include a transformer-based model (e.g., a generative pre-trained transformer (GPT) model). The language model(s) 112 can be or include a bidirectional encoder representations from transformers (BERT) model, in some implementations. The tokenizer 108 can execute the machine-learning model to generate outputs. The tokenizer 108 can receive data to provide as input to the language model(s) 112, which can include document metadata, extracted term candidates, document segments, and/or any data from other text sources.

The tokenizer 108 can include at least one neural network (e.g., language model(s) 112). The language model(s) 112 can include an input layer, an output layer, and/or one or more intermediate layers, such as hidden layers, which can each have respective nodes. That is, the language model(s) 112 process input text features through structured layers for term extraction. For example, the input layer can accept document segments and context for processing. For example, the output layer returns extracted terms based on the specified criterion. For example, the intermediate layers facilitate context-aware term identification by encoding text relationships.

In some implementations, the system 100 can configure (e.g., train, update, fine-tune, apply transfer learning to) the language model(s) 112 by modifying or updating one or more parameters, such as weights and/or biases, of various nodes of the language model(s) 112 responsive to evaluating estimated outputs of the language model(s) 112 (e.g., generated responsive to domain-specific term extraction tasks). The tokenizer 108 can be or include various neural network models, including models for operating on or generating data including but not limited to private vocabulary terms, domain-specific text features, vocabulary refinement suggestions, query samples, and/or various combinations thereof.

In some implementations, the uniqueness criterion can include criteria for a plurality of frequencies of the one or more terms being below a threshold frequency (e.g., below 0.1% in standard corpora, less than 50 appearances in open-domain language models, used only in internal documents, and/or absent or missing in external vocabularies) in a vocabulary of the tokenizer. For example, the tokenizer 108 can set the threshold frequency based on a plurality of occurrences (e.g., document-specific appearances, internal knowledge base frequency, frequency in product specifications, technical manual frequency) of the plurality of domain-specific terms within the input data 104 (e.g., training manuals, technical specifications, engineering documents, company-specific data sources).

Additionally, tokenizer 108 can determine the threshold based on how often the domain-specific terms appear (e.g., the number of times found in internal document sections, referenced in specific project files, and/or mentioned in private datasets) within the internal documents. That is, the tokenizer 108 can prioritize terms that are relevant to the specialized content and/or context but not overly common (e.g., being unique to specific documents, not often (e.g., appearing less than 0.05% across external corpora) used externally, primarily used in private contexts, and/or not common (e.g., occurring fewer than 5 times per million words) in general language) in general language (e.g., dictionary, external corpora, general-purpose datasets).

In some implementations, the extraction stage can be the stage in the retrieval pipeline in which the system 100 can identify and divide relevant sections of text for downstream processing. The system 100 can include at least one extractor 120. The extractor 120 can extract, from the plurality of documents, a plurality of portions of the plurality of documents (e.g., input data 104). That is, the extractor 120 can segment the plurality of documents based on at least one marker (e.g., punctuation, paragraph breaks, section headers, and/or any predefined keywords) to segment content (e.g., sentences, paragraphs, subsections, and/or any logical document divisions) of the plurality of documents into the plurality of portions. For example, during the extraction stage, the extractor 120 can use punctuation to divide text into sentences for analysis. For example, the extractor 120 can use section headers to create portions aligned with specific topics.

In some implementations, the input data 104 can include any documents, textual content, or structured information. The extractor 120 can segment and/or chunk the input data 104 by sentence boundaries, paragraphs, punctuation marks, keywords, and/or any document-specific markers. For example, the extractor 120 can divide text based on punctuation to create sentence-level chunks for analysis. For example, the extractor 120 can use predefined keywords or headings, such as “Overview” or “Details,” to delineate sections for processing. The extractor 120 can use various techniques and markers to facilitate segmentation across documents. That is, the extractor 120 can use various techniques and/or functions to segment the input data 104 for processing by the query generator 124.

In some implementations, the extractor 120 can determine a chunk size to improve the quality of generated questions by query generator 124. That is, the extractor 120 can determine and/or select chunk sizes by adjusting hyperparameters based on content type and task requirements. For example, larger chunk sizes can retain more context within a segment. For example, smaller chunk sizes can increase specificity and relevance. To determine the optimal and/or desired chunk size, the extractor 120 can sample document portions of varying lengths, generate corresponding questions, and evaluate the quality of these questions. The extractor 120 can then tune chunk size parameters iteratively to balance context retention and specificity.

In some implementations, the extractor 120 can determine a chunk size to enhance downstream processing, such as query generation by the query generator 124. That is, the extractor 120 can adjust chunk sizes by tuning hyperparameters based on content type and segmentation needs. For example, larger chunk sizes can retain more contextual information within each segment, which can support comprehensive analysis but can introduce extraneous content. For example, smaller chunk sizes can improve focus and specificity but can reduce context, potentially impacting the relevance of subsequent processing tasks. To determine the chunk size, the extractor 120 can sample portions of varying lengths, analyze the accuracy of content segmentation, and/or update hyperparameters based on data consistency across segment sizes. That is, hyperparameters can be configuration settings used to control the segmentation process, such as chunk length thresholds or minimum context requirements (e.g., word count per segment, maximum token length, or punctuation-based boundaries).

In some implementations, the extractor 120 can determine and/or select chunk sizes by adjusting hyperparameters based on content type and segmentation requirements. To determine the chunk size, the extractor 120 can sample document portions of varying lengths, pair each portion with corresponding questions, and store the pairs in the training dataset 128. The extractor 120 can further tune chunk size parameters iteratively to balance context retention and specificity. In some implementations, the extractor 120 can sample document segments to determine chunk sizes that support consistent pairing of questions with document portions, adjusting hyperparameters such as chunk length thresholds or minimum context requirements (e.g., word count per segment, maximum token length, or punctuation-based boundaries) to maintain the training dataset 128.

In some implementations, the query generation stage can be the stage in the retrieval pipeline in which the system 100 can generate queries based on segmented document portions (e.g., representing likely search inputs). The system 100 can include at least one query generator 124. The query generator 124 can generate, based at least on the plurality of portions (e.g., provided by the extractor 120), a plurality of queries corresponding to the plurality of portions. In some implementations, the query generator 124 can apply the extracted data (e.g., segmented) and/or one or more prompts to guide a language model(s) 112 to generate queries. In this example, the prompt can be “Based on the context provided, please generate multiple questions that align with real user scenarios, and output them in JSON format, with only the ‘question’ field included,” and the language model(s) 112 can process the extracted data (e.g., “:\nBootloader and BCTs\nLinux kernel binary and source code (available via nv-tegra)\nReference file system (basic, currently derived from Ubuntu Linux)\nSelect Drivers\nDemonstration applications\nHost utilities for flashing\nMore information can be found here—L4T—Embedded\n1.5. Motivation\nTH500 chip bring-up used BaseOS. Various benefits were seen because of using a widely used OS across various SW teams. \n1.5.1. Potential Advantages\nSpeed of Resolution\t\nSpeed of resolution of various issues at SLT/SSG. As various SW teams use L4T as their default development vehicle, it is easier to repro and debug issues if the issues were found on L4T.\nThis was also evident on TH500, where BaseOS issues were repro and resolved in a speedier manner, without much involvement of MODS team.”) to output queries aligned with specific content. That is, the portions of the extracted data can represent the division of segments such that at least one segment can be used as an input for query generation. Further in this example, the output of the language model(s) 112 can be “[{“question”: “How can moving to L4T benefit the resolution of issues at SLT/SSG?”}, {“question”: “What are the potential advantages of using L4T instead of TinyLinux for flash infrastructure?”}, {“question”: “Why is L4T considered widely used across SW and how does this benefit MODS teams?”}].” Additionally, the output can be in a JSON format or another suitable format such as, but not limited to, XML, CSV, plain text, and/or any structured format.

In some implementations, language model 112 can be a neural network trained to also generate queries corresponding to portions of documents. That is, language model 112 can be trained to extract domain-specific terms (described above with reference to the tokenizer 108) and can be trained to generate questions from the various extracted and/or segmented input data 104. For example, the language model(s) 112 can be executed in parallel such that tokens and queries can be generated simultaneously based at least on the input data 104.

In some implementations, the query generator 124 can prompt the language model 112 with a plurality of instructions (e.g., “Generate questions related to configuration details in the content,” “Identify terms relevant to diagnostic procedures within this context,” “Generate questions based on performance metrics outlined in this section”) based on the content (e.g., content of the text) and context (e.g., how the text relates to other parts of the documents or the purpose of the content) of the plurality of portions and corresponding with at least one parameter (e.g., criteria or guidelines). That is, the query generator 124 can determine or identify the content of the text by analyzing keywords or terms within each portion. For example, the query generator 124 can identify a topic such as “system architecture” is the content by matching words within the segment. For example, the query generator 124 can determine “performance metrics” is the content by detecting phrases associated with technical specifications. Additionally, the query generator 124 can determine or identify the context of the text by associating the text portion with surrounding and/or neighboring document sections. For example, the query generator 124 can identify a section as background information is the context by linking it to an introductory document segment. For example, the query generator 124 can determine a troubleshooting context is the context by associating it with sections labeled for problem resolution.

In some implementations, the query generator 124 can determine or identify a parameter by applying predefined settings relevant to the purpose of the document or user requirements. For example, a parameter can be, but is not limited to, specific question formats, keyword density, sentence length, specificity levels, and/or any semantic similarity thresholds. Thus, the prompt can include a question and/or relevant context markers to guide the language model 112 by identifying and/or determining the content and context of each document portion and identifying and/or determining the parameters for generating relevant questions.

In some implementations, the query generator 124 can use the language model(s) 112 to output questions aligned with the content of document segments (e.g., structured as JSON objects, grouped by document section, categorized by topic, and/or any customized query format). For example, the query generator 124 can output queries that simulate possible user searches within private document collections. In some implementations, the query generator 124 can generate and/or create a training dataset 128 to include pairs of queries (e.g., generated by language model 112) and document chunks (e.g., extracted by extractor 120 to segmented portions of the original documents). That is, the language model 112 can generate queries and/or questions based on the document chunks. The queries can simulate user input, representing how someone might search for information, for example, within the private document set. For example, for a document chunk about the benefits of a specific technology, a generated query can be, “What are the advantages of using technology X?” In this example, the document chunks can represent the content that the language model 112 should be trained to retrieve in response to relevant queries.

In some implementations, the query generator 124 can maintain, execute, train, and/or update one or more machine-learning models during the query stage. For example, the language model(s) 112 can be trained and/or updated to generate contextually relevant questions based on extracted document segments. The language model(s) 112 can be or include a transformer-based model (e.g., a generative pre-trained transformer (GPT) model). The query generator 124 can execute the language model 112 to generate outputs (e.g., training data to pair with portions of documents and/or store in training datasets 128). The query generator 124 can receive data to provide as input to the language model(s) 112, which can include extracted document portions, segmented content specific to user scenarios, domain-specific feedback, and/or any data from structured datasets. In some implementations, the system 100 can configure (e.g., train, update, fine-tune, apply transfer learning to) the language model(s) 112 by modifying or updating one or more parameters, such as weights and/or biases, of various nodes of the language model(s) 112 responsive to evaluating estimated outputs of the language model(s) 112 (e.g., generated responsive to training metrics related to question relevance and accuracy). The query generator 124 can be or include various neural network models, including models that can operate on or generate data including but not limited to private vocabulary, structured question formats, domain-specific term identification, content segmentation, and/or various combinations thereof.

In some implementations, the query generator 124 can generate and/or create a training dataset 128 by pairing generated queries with corresponding document portions. That is, the output of language model 112 and the output of the extractor 120 can be paired as query-document pairs for training purposes. For example, the query generator 124 can use extracted sections on system architecture and generate related queries to create paired data (e.g., to store in training dataset 128) for training. For example, the query generator 124 can generate queries for troubleshooting sections and pair these with document portions describing diagnostic steps. Additionally, the query generator 124 can perform pairing by matching queries with document portions based on content similarity metrics. For example, queries directed to performance parameters can be paired (e.g., in the training dataset) with document portions that describe performance metrics or related technical data. In some implementations, the training dataset 128 can be provided to the tokenizer 108 to train, update, and/or implement embedding model(s) 116.

In some implementations, the embedding stage can be the stage in the retrieval pipeline in which the system 100 can generate embeddings to represent document portions and queries in a semantic space. The embedding model(s) 116 can include any one or more artificial intelligence models (e.g., machine learning models, supervised models, neural network models, deep neural network models), rules, heuristics, algorithms, functions, or various combinations thereof to perform operations including embedding generation, such as transforming text data into vector representations for retrieval tasks. That is, embedding model(s) 116 can be a neural network trained to map domain-specific terms to dense vector spaces that capture semantic relationships.

In some implementations, the embedding model(s) 116 can output embeddings of document chunks and queries (e.g., vectorized representations, contextual embeddings, domain-relevant feature vectors, and/or any query-document alignment indicators). For example, the embedding model(s) 116 can process document chunks to output vector outputs that capture relational information. For example, the embedding model(s) 116 can generate embeddings for queries that align semantically with document content. In some implementations, the embedding model(s) 116 can be provided and/or implemented to perform embedding retrievals in private domains and/or secure data environments. That is, once the retrieval model has converged (i.e., achieved a threshold level of retrieval accuracy in matching queries with relevant documents), the embedding model(s) 116 can be used to retrieve semantically similar documents in various private data collections.

In some implementations, the embedding model(s) 116 can be configured (e.g., trained, updated, fine-tuned, apply transfer learning to) by modifying or updating one or more parameters, such as weights and/or biases, of various nodes within the embedding model(s) 116 responsive to evaluating estimated outputs of the embedding model(s) 116 (e.g., generated in response to receiving training examples from training dataset 128 and tokenized vocabulary from vocabulary dataset 118). That is, the embedding model(s) 116 can be updated by learning from training pairs of document portions and queries. For example, the vocabulary dataset 118 can include domain-specific terms used for semantic mapping, and the training dataset 128 can include paired queries and document portions for supervised learning. In this example, the embedding model(s) 116 can use the vocabulary dataset 118 and the training dataset 128 to learn mappings between queries and documents based on semantic content. Additionally, the embedding model(s) 116 can include various neural network architectures, including models capable of semantic encoding such as transformers, recurrent networks, feed-forward networks, and/or convolutional layers.

In some implementations, the embedding model(s) 116 can be configured (e.g., trained, updated, fine-tuned, has transfer learning performed, etc.) based at least on the domain-specific (tokenized) vocabulary in vocabulary dataset 118 and/or training data in training dataset 128. For example, one or more example pairs of queries and corresponding document portions of the training data and/or domain-specific vocabulary of an entity (e.g., company, organization, department, sole proprietor, research group) can be applied (e.g., by the embedding model(s) 116) as input to an encoder to generate an estimated output. The estimated output can be evaluated and/or compared with target embeddings (or expected outputs) of the training data that correspond with the one or more example pairs of queries and document portions of the training data and/or domain-specific vocabulary of the entity, and the embedding model(s) 116 can be updated based at least on the comparison results and/or evaluation metrics. For example, based at least on an output of similarity scoring, one or more parameters (e.g., weights and/or biases) of embedding model(s) 116 can be updated.

In some implementations, the embedding model(s) 116 can maintain, execute, train, and/or update one or more machine-learning models during the embedding stage. In some implementations, the machine-learning model(s) can include any type of deep learning machine-learning models capable of semantic vector encoding (e.g., embedding query-document pairs into dense spaces) to support efficient document retrieval. That is, the vector encodings can be vector representations (or embeddings) that capture the semantic meaning or relationships between items such as words, entities, or domain-specific concepts in a numerical format that facilitates similarity-based retrieval. For example, vector embeddings generated from technical terms within private documents can be used to identify semantically related documents or sections.

Additionally, the machine-learning model(s) can be trained and/or updated to embed private vocabulary and contextually relevant document information, among other domain-specific tasks. The machine-learning model(s) can be or include a transformer-based model (e.g., a generative pre-trained transformer (GPT) model). The embedding model(s) 116 can execute these models to generate embeddings. The embedding model(s) 116 can receive data to provide as input, which can include questions and/or domain-relevant document segments from users and/or internal data sources. In some implementations, the embedding model(s) 116 can include an input layer, an output layer, and/or one or more intermediate layers, such as hidden layers, which can each have respective nodes. That is, the embedding model(s) 116 can process input data through multiple layers to generate embeddings. For example, the input layer receives vectorized text data. For example, the output layer produces the final embedding vectors for retrieval tasks. For example, the intermediate layers encode relationships between domain-specific terms.

With reference to FIG. 2, an example flow diagram illustrating a method for embedding-based document retrieval in a text retrieval pipeline, in accordance with some implementations of the present disclosure. It should be understood that this and other arrangements described herein are set forth only as examples. Other arrangements and elements (e.g., machines, interfaces, functions, orders, groupings of functions, etc.) can be used in addition to or instead of those shown, and some elements can be omitted altogether. Further, many of the elements described herein are functional entities that can be implemented as discrete or distributed components or in conjunction with other components, and in any combination and location. Various functions described herein as being performed by entities can be carried out by hardware, firmware, and/or software. For example, various functions can be carried out using one or more processor executing instructions stored in one or more memories. For example, in some implementations, the system and methods described herein can be implemented using one or more generative language models (e.g., as described in FIGS. 3A-3C), one or more computing devices or components thereof (e.g., as described in FIG. 4), and/or one or more data centers or components thereof (e.g., as described in FIG. 5).

Now referring to FIG. 2, each block of method 200, described herein, includes a computing process that can be performed using any combination of hardware, firmware, and/or software. For example, various functions can be carried out using one or more processors executing instructions stored in one or more memories. The method can also be embodied as computer-usable instructions stored on computer storage media. The method can be provided by a standalone application, a service or hosted service (standalone or in combination with another hosted service), as a microservice via an application programming interface (API) or a plug-in to another product, to name a few. In addition, method 200 is described, by way of example, with respect to the system of FIG. 1. However, this method can additionally or alternatively be executed by any one system, or any combination of systems, including, but not limited to, those described herein.

FIG. 2 is a flow diagram showing a method 200 for inputting, extracting, generating, and/or updating operations, in accordance with some implementations of the present disclosure. Various operations of method 200 can relate to improving the efficiency and relevance of document retrieval in embedding-based systems. Existing systems often rely on and/or use general-purpose vocabularies and static query-document matching, which can lead to inaccurate retrieval results for domain-specific content. The existing technological problems can arise when these systems lack adaptability to private or specialized terminology, resulting in reduced retrieval performance and increased manual intervention. Method 200 of FIG. 2 can solve these technological problems by implementing dynamic embedding updates and domain-specific vocabulary integration, thereby improving retrieval accuracy and system alignment with domain-specific content.

The method 200, at block 210, includes inputting one or more terms that satisfy a uniqueness criterion to a tokenizer. That is, inputting can cause the processing circuits to tokenize the one or more terms (e.g., extracted from a plurality of documents) into a vocabulary dataset. Additionally, the processing circuits can generate terms (e.g., using a language model) that satisfy a predefined uniqueness criterion from a plurality of documents (e.g., corresponding with a domain) and input them to the processing circuits to prompt tokenization into a vocabulary dataset. For example, the processing circuits can use a language model (LLM) (or neural network models, unsupervised models, decision trees) to identify domain-specific terms from various internal documents or content based on their low frequency in general language datasets. Additionally, the processing circuits can perform the inputting operation by prompting the LLM to detect infrequent technical terms and input these terms to the tokenizer for structured tokenization.

In some implementations, the processing circuits can extract the one or more terms from the plurality of documents by using an LLM trained to identify data segments based on the uniqueness criterion. That is, the processing circuits can employ the LLM to identify and/or extract text that contain terms meeting and/or satisfying the uniqueness threshold. For example, the LLM can scan document segments to identify terms appearing infrequently in standard datasets. Additionally, the processing circuits can refine extraction to analyze terms relevant to the uniqueness criterion. That is, the processing circuits can prioritize segments that highlight private or specialized vocabulary (e.g., internal procedures, private workflows, organization-specific standards). For example, the LLM can identify terms unique to specific procedures or components used internally.

In some implementations, the processing circuits can prompt the LLM with instructions to extract terms in the plurality of documents that meet the uniqueness criterion. That is, the processing circuits can guide the LLM to locate terms that are unique and/or specific to a particular context (e.g., industry-specific, rarely used terms, private jargon). For example, the LLM can be instructed to extract terms that occur below a certain frequency across general datasets but are common within internal documents. Additionally, the processing circuits can include additional parameters in the instructions to narrow the modeling by the LLM on domain-specific terms. That is, the processing circuits can set parameters (e.g., minimum occurrence frequency, usage relevance, domain-specific context) for term frequency or contextual usage to meet extraction requirements. For example, an instruction can facilitate extracting terms appearing only in sections for private technology.

In some implementations, the processing circuits can define the uniqueness criterion based on frequencies of terms being below a threshold frequency in the vocabulary of the tokenizer (e.g., stored in a vocabulary dataset). That is, the processing circuits can set a frequency threshold that terms must meet to be considered unique. For example, the processing circuits can determine that terms appearing below 0.05% in external datasets qualify for inclusion in the private vocabulary. Additionally, the processing circuits can filter terms that meet the criterion for integration into the vocabulary dataset. For example, terms that meet the uniqueness threshold can be stored for future retrieval (e.g., by the embedding model).

In some implementations, the processing circuits can set the threshold frequency based on occurrence or co-occurrence frequencies of terms within the plurality of documents. That is, the processing circuits can analyze how often terms appear individually or in conjunction with other terms to establish relevance. For example, terms that occur frequently together in specific document sections can be prioritized in the vocabulary dataset. Additionally, the processing circuits can determine the threshold by analyzing and determining the collective occurrences of domain-specific terms. That is, the processing circuits can update the threshold frequency to capture terms characteristic of the private domain. For example, a term that frequently co-occurs with technical terms can be included (e.g., despite a low individual frequency).

The method 200, at block 220, includes extracting a plurality of portions from the plurality of documents. That is, the processing circuits can identify and segment sections within documents to create portions for query generation. The document can include the terms corresponding with a domain (e.g., a company, organization, department, research group, and/or any proprietary entity). For example, the processing circuits can segment text from a range of documents by dividing content at natural language markers, such as periods, question marks, or other punctuation, to create informational chunks. Additionally, the processing circuits can perform extraction by using markers such as, section headers or keywords to divide documents into defined portions. For example, the processing circuits can extract sections that contain procedural information or step-by-step instructions.

In some implementations, the processing circuits can extract the plurality of portions by segmenting the plurality of documents based on at least one marker. That is, the processing circuits can apply segmentation markers, such as punctuation or specific boundary indicators, to divide document content into the plurality of portions. For example, the processing circuits can detect periods, question marks, or section headers to separate the content into discrete portions for processing. Additionally, the processing circuits can identify markers that indicate topic shifts or logical breaks within the documents. That is, the processing circuits can apply these markers as boundaries to separate relevant content.

The method 200, at block 230, includes generating queries based at least on the plurality of portions. That is, the processing circuits can generate queries from each extracted document portion, simulating questions a user might pose related to the content. For example, the processing circuits can form queries based on operational steps described within document portions, producing questions like “How to complete task X?” or “What are the steps for process Y?” For example, the processing circuits can generate queries that reflect common inquiry structures. In some implementations, the processing circuits can sample the documents to determine a chunk size related to query relevance and content specificity. For example, the processing circuits can vary chunk sizes, such as segments of 50, 100, or 200 words, and determine which size can obtain context-relevant queries. Additionally, the processing circuits can generate chunks of the documents and pair the chunks with corresponding generated questions such that at least one (e.g., each) pair forms a dataset entry for embedding model training. For example, the processing circuits can align the extracted chunk with a question reflecting the content of the chunk.

In some implementations, the processing circuits can generate the plurality of queries by using a large language model (LLM) trained on content and context of the extracted plurality of portions. That is, the processing circuits can use the LLM to interpret the segmented content and generate questions relevant to the information in at least one (e.g., each) portion. For example, the LLM can output queries that correspond to the technical descriptions or procedural steps present in each content segment. Additionally, the processing circuits can apply the LLM to analyze at least one (e.g., each) document portion for contextual relevance to refine query generation. That is, the processing circuits can prompt the LLM to include terms or phrases that align with the content of the document. For example, the LLM can generate queries such as “How to troubleshoot component X?”

In some implementations, the processing circuits can generate queries based on content including textual information in the plurality of portions. The context can include an association (e.g., query relevance to document section) between each query and its respective portion. That is, the processing circuits can identify text within at least one (e.g., each) document portion and determine connections between queries and the specific content from which they originate. For example, the processing circuits can verify that at least one (e.g., each) query reflects the information in its corresponding document segment. Additionally, the processing circuits can maintain an association between the generated queries and the originating document portions. That is, the processing circuits can track the linkage of queries to their source segments. For example, a query about setup steps can be linked to the portion describing setup instructions.

In some implementations, the processing circuits can prompt the LLM with instructions based on the content and context of the plurality of portions to generate the plurality of queries. That is, the processing circuits can provide the LLM with prompts that guide query creation according to content features and contextual relevance within the portions. For example, instructions can direct the LLM to generate questions on technical specifications or operational procedures described in the segments. Additionally, the processing circuits can include at least one parameter to further refine query generation. That is, the processing circuits can apply parameters, such as specific keywords or query structures, to facilitate alignment with intended search criteria. For example, a parameter can specify the use of industry terminology relevant to each portion.

The method 200, at block 240, includes updating an embedding model using the tokenizer, based on the plurality of queries, the plurality of portions, and the vocabulary dataset. That is, the processing circuits can train and/or update the embedding model to align with the specialized vocabulary and relationships between queries, document segments, and terms. For example, the processing circuits can use tokenized terms (e.g., private terms, unique technical identifiers, organization-specific acronyms) and their associated queries (e.g., generated user inquiries, procedural questions, technical prompts) and chunks (e.g., segmented document portions, extracted content segments, specific document sections) to fine-tune the representations of private language and technical concepts in the embedding model. Additionally, the processing circuits can perform the updating by applying the vocabulary dataset to refine vector embeddings. For example, the processing circuits can update embeddings to prioritize contextually relevant results for technical queries.

In some implementations, the processing circuits can employ the embedding model that includes a transformer model trained to convert textual inputs into continuous vector representations. That is, the processing circuits can use the transformer model to process text by generating embeddings that capture semantic relationships. For example, the transformer model (e.g., BERT-based models, GPT architectures, domain-adapted encoders) can encode terms used in domain-specific contexts, linking them to technical concepts. Additionally, the processing circuits can perform embedding generation by passing tokens through multiple attention layers. That is, the processing circuits can use attention mechanisms (e.g., contextual attention, layered attention techniques) to contextualize each term within the text. For example, multi-layer attention can represent relationships between terms, enhancing retrieval accuracy in specialized content collections. In some implementations, the processing circuits can refine the embeddings by using pairs of data from the training dataset and the vocabulary dataset. Specifically, the training dataset can contain aligned pairs of queries and document portions and the vocabulary dataset can contain domain-specific tokens with unique token IDs. By pairing these datasets, the embedding model can establish associations between terms and contextually related content. For example, embeddings generated from paired query-document examples can be updated to prioritize context-specific retrieval for technical queries.

Disclosed implementations can be included in a variety of different systems such as automotive systems (e.g., a control system for an autonomous or semi-autonomous machine, a perception system for an autonomous or semi-autonomous machine), systems implemented using a robot or robotic platform, aerial systems, medial systems, boating systems, smart area monitoring systems, systems for performing deep learning operations, systems for performing simulation operations (e.g., in a driving or vehicle simulation, in a robotics simulation, in a smart cities or surveillance simulation, etc.), systems for performing digital twin operations (e.g., in conjunction with a collaborative content creation platform or system, such as, without limitation, NVIDIA's OMNIVERSE and/or another platform, system, or service that uses USD or OpenUSD data types), systems implemented using an edge device, systems incorporating one or more virtual machines (VMs), systems for performing synthetic data generation operations (e.g., using one or more neural rendering fields (NERFs), gaussian splat techniques, diffusion models, transformer models, etc.), systems implemented at least partially in a data center, systems for performing conversational AI operations, systems implementing one or more language models-such as one or more large language models (LLMs), one or more small language models (SLMs), one or more vision language models (VLMs), one or more multi-modal language models, etc., systems for performing light transport simulation, systems for performing collaborative content creation for 3D assets (e.g., using universal scene descriptor (USD) data, such as OpenUSD, computer aided design (CAD) data, 2D and/or 3D graphics or design data, and/or other data types), systems implemented at least partially using cloud computing resources, and/or other types of systems.

### Example Language Models

In at least some implementations, language models, such as large language models (LLMs), vision language models (VLMs), multi-modal language models (MMLMs), and/or other types of generative artificial intelligence (AI) can be implemented. Generally, the language models can generate queries, identify terms, and determine associations within input data to facilitate operations in retrieval, tokenization, and embedding processes. These models can be capable of understanding, summarizing, translating, and/or otherwise generating text (e.g., natural language text, code, etc.), images, video, computer aided design (CAD) assets, OMNIVERSE and/or METAVERSE file information (e.g., in USD format, such as OpenUSD), and/or the like, based on the context provided in input prompts or queries. These language models can be considered “large,” in implementations, based on the models being trained on massive datasets and having architectures with large number of learnable network parameters (weights and biases)—such as millions or billions of parameters. The LLMs/VLMs/MMLMs/etc. can be implemented for summarizing textual data, analyzing and extracting insights from data (e.g., textual, image, video, etc.), and generating new text/image/video/etc. in user-specified styles, tones, and/or formats. The LLMs/VLMs/MMLMs/etc. of the present disclosure can be used exclusively for text processing, in implementations, whereas in other implementations, multi-modal LLMs can be implemented to accept, understand, and/or generate text and/or other types of content like images, audio, 2D and/or 3D data (e.g., in USD formats), and/or video. For example, vision language models (VLMs), or more generally multi-modal language models (MMLMs), can be implemented to accept image, video, audio, textual, 3D design (e.g., CAD), and/or other inputs data types and/or to generate or output image, video, audio, textual, 3D design, and/or other output data types.

Various types of LLMs/VLMs/MMLMs/etc. architectures can be implemented in various implementations. For example, different architectures can be implemented that use different techniques for understanding and generating outputs—such as text, audio, video, image, 2D and/or 3D design or asset data, etc. In some implementations, LLMs/VLMs/MMLMs/etc. architectures such as recurrent neural networks (RNNs) or long short-term memory networks (LSTMs) can be used, while in other implementations transformer architectures—such as those that rely on self-attention and/or cross-attention (e.g., between contextual data and textual data) mechanisms—can be used to understand and recognize relationships between words or tokens and/or contextual data (e.g., other text, video, image, design data, USD, etc.). One or more generative processing pipelines that include LLMs/VLMs/MMLMs/etc. can also include one or more diffusion block(s) (e.g., denoisers). The LLMs/VLMs/MMLMs/etc. of the present disclosure can include encoder and/or decoder block(s). For example, discriminative or encoder-only models like BERT (Bidirectional Encoder Representations from Transformers) can be implemented for tasks that involve language comprehension such as classification, sentiment analysis, question answering, and named entity recognition. As another example, generative or decoder-only models like GPT (Generative Pretrained Transformer) can be implemented for tasks that involve language and content generation such as text completion, story generation, and dialogue generation. LLMs/VLMs/MMLMs/etc. that include both encoder and decoder components like T5 (Text-to-Text Transformer) can be implemented to understand and generate content, such as for translation and summarization. These examples are not intended to be limiting, and any architecture type—including but not limited to those described herein—can be implemented depending on the particular implementation and the task(s) being performed using the LLMs/VLMs/MMLMs/etc.

In various implementations, the LLMs/VLMs/MMLMs/etc. can be trained using unsupervised learning, in which an LLMs/VLMs/MMLMs/etc. learns patterns from large amounts of unlabeled text/audio/video/image/design/USD/etc. data. Due to the extensive training, in implementations, the models cannot require task-specific or domain-specific training. LLMs/VLMs/MMLMs/etc. that have undergone extensive pre-training on vast amounts of unlabeled data can be referred to as foundation models and can be adept at a variety of tasks like question-answering, summarization, filling in missing information, translation, image/video/design/USD/data generation. Some LLMs/VLMs/MMLMs/etc. can be tailored for a specific use case using techniques like prompt tuning, fine-tuning, retrieval augmented generation (RAG), adding adapters (e.g., customized neural networks, and/or neural network layers, that tune or adjust prompts or tokens to bias the language model toward a particular task or domain), and/or using other fine-tuning or tailoring techniques that optimize the models for use on particular tasks and/or within particular domains.

In some implementations, the LLMs/VLMs/MMLMs/etc. of the present disclosure can be implemented using various model alignment techniques. For example, in some implementations, guardrails can be implemented to identify improper or undesired inputs (e.g., prompts) and/or outputs of the models. In doing so, the system can use the guardrails and/or other model alignment techniques to either prevent a particular undesired input from being processed using the LLMs/VLMs/MMLMs/etc., and/or preventing the output or presentation (e.g., display, audio output, etc.) of information generating using the LLMs/VLMs/MMLMs/etc. In some implementations, one or more additional models—or layers thereof—can be implemented to identify issues with inputs and/or outputs of the models. For example, these “safeguard” models can be trained to identify inputs and/or outputs that are “safe” or otherwise okay or desired and/or that are “unsafe” or are otherwise undesired for the particular application/implementation. As a result, the LLMs/VLMs/MMLMs/etc. of the present disclosure can be less likely to output language/text/audio/video/design data/USD data/etc. that can be offensive, vulgar, improper, unsafe, out of domain, and/or otherwise undesired for the particular application/implementation.

In some implementations, the LLMs/VLMs/etc. can be configured to or capable of accessing or using one or more plug-ins, application programming interfaces (APIs), databases, data stores, repositories, etc. For example, for certain tasks or operations that the model is not ideally suited for, the model can have instructions (e.g., as a result of training, and/or based on instructions in a given prompt) to access one or more plug-ins (e.g., 3^{rd} party plugins) for help in processing the current input. In such an example, where at least part of a prompt is related to restaurants or weather, the model can access one or more restaurant or weather plug-ins (e.g., via one or more APIs) to retrieve the relevant information. As another example, where at least part of a response requires a mathematical computation, the model can access one or more math plug-ins or APIs for help in solving the problem(s), and can then use the response from the plug-in and/or API in the output from the model. This process can be repeated—e.g., recursively—for any number of iterations and using any number of plug-ins and/or APIs until a response to the input prompt can be generated that addresses each ask/question/request/process/operation/etc. As such, the model(s) can not only rely on its own knowledge from training on a large dataset(s), but also on the expertise or optimized nature of one or more external resources—such as APIs, plug-ins, and/or the like.

In some implementations, multiple language models (e.g., LLMs/VLMs/MMLMs/etc., multiple instances of the same language model, and/or multiple prompts provided to the same language model or instance of the same language model can be implemented, executed, or accessed (e.g., using one or more plug-ins, user interfaces, APIs, databases, data stores, repositories, etc.) to provide output responsive to the same query, or responsive to separate portions of a query. In at least one implementation, multiple language models e.g., language models with different architectures, language models trained on different (e.g. updated) corpuses of data can be provided with the same input query and prompt (e.g., set of constraints, conditioners, etc.). In one or more implementations, the language models can be different versions of the same foundation model. In one or more implementations, at least one language model can be instantiated as multiple agents—e.g., more than one prompt can be provided to constrain, direct, or otherwise influence a style, a content, or a character, etc., of the output provided. In one or more example, non-limiting implementations, the same language model can be asked to provide output corresponding to a different role, perspective, character, or having a different base of knowledge, etc.—as defined by a supplied prompt.

In any one of such implementations, the output of two or more (e.g., each) language models, two or more versions of at least one language model, two or more instanced agents of at least one language model, and/or two more prompts provided to at least one language model can be further processed, e.g., aggregated, compared or filtered against, or used to determine (and provide) a consensus response. In one or more implementations, the output from one language model—or version, instance, or agent—can be provided as input to another language model for further processing and/or validation. In one or more implementations, a language model can be asked to generate or otherwise obtain an output with respect to an input source material, with the output being associated with the input source material. Such an association can include, for example, the generation of a caption or portion of text that is embedded (e.g., as metadata) with an input source text or image. In one or more implementations, an output of a language model can be used to determine the validity of an input source material for further processing, or inclusion in a dataset. For example, a language model can be used to assess the presence (or absence) of a target word in a portion of text or an object in an image, with the text or image being annotated to note such presence (or lack thereof). Alternatively, the determination from the language model can be used to determine whether the source material should be included in a curated dataset, for example and without limitation.

FIG. 3A is a block diagram of an example generative language model system 300 suitable for use in implementing at least some implementations of the present disclosure. Generally, the example generative language model system 300 can process input data to generate queries, extract relevant terms, and support embedding generation for retrieval applications. In the example illustrated in FIG. 3A, the generative language model system 300 includes a retrieval augmented generation (RAG) component 392, an input processor 305, a tokenizer 310, an embedding component 320, plug-ins/APIs 395, and a generative language model (LM) 330 (which can include an LLM, a VLM, a multi-modal LM, etc.).

At a high level, the input processor 305 can receive an input 301 comprising text and/or other types of input data (e.g., audio data, video data, image data, sensor data (e.g., LiDAR, RADAR, ultrasonic, etc.), 3D design data, CAD data, universal scene descriptor (USD) data—such as OpenUSD, etc.), depending on the architecture of the generative LM 330 (e.g., LLM/VLM/MMLM/etc.). In some implementations, the input 301 includes plain text in the form of one or more sentences, paragraphs, and/or documents. Additionally or alternatively, the input 301 can include numerical sequences, precomputed embeddings (e.g., word or sentence embeddings), and/or structured data (e.g., in tabular formats, JSON, or XML). In some implementations in which the generative LM 330 is capable of processing multi-modal inputs, the input 301 can combine text (or can omit text) with image data, audio data, video data, design data, USD data, and/or other types of input data, such as but not limited to those described herein. Taking raw input text as an example, the input processor 305 can prepare raw input text in various ways. For example, the input processor 305 can perform various types of text filtering to remove noise (e.g., special characters, punctuation, HTML tags, stopwords, portions of an image(s), portions of audio, etc.) from relevant textual content. In an example involving stopwords (common words that tend to carry little semantic meaning), the input processor 305 can remove stopwords to reduce noise and focus the generative LM 330 on more meaningful content. The input processor 305 can apply text normalization, for example, by converting all characters to lowercase, removing accents, and/or or handling special cases like contractions or abbreviations to ensure consistency. These are just a few examples, and other types of input processing can be applied.

In some implementations, a RAG component 392 (which can include one or more RAG models, and/or can be performed using the generative LM 330 itself) can be used to retrieve additional information to be used as part of the input 301 or prompt. RAG can be used to enhance the input to the LLM/VLM/MMLM/etc. with external knowledge, so that answers to specific questions or queries or requests are more relevant—such as in a case where specific knowledge is required. The RAG component 392 can fetch this additional information (e.g., grounding information, such as grounding text/image/video/audio/USD/CAD/etc.) from one or more external sources, which can then be fed to the LLM/VLM/MMLM/etc. along with the prompt to improve accuracy of the responses or outputs of the model.

For example, in some implementations, the input 301 can be generated using the query or input to the model (e.g., a question, a request, etc.) in addition to data retrieved using the RAG component 392. In some implementations, the input processor 305 can analyze the input 301 and communicate with the RAG component 392 (or the RAG component 392 can be part of the input processor 305, in implementations) in order to identify relevant text and/or other data to provide to the generative LM 330 as additional context or sources of information from which to identify the response, answer, or output 390, generally. For example, where the input indicates that the user is interested in a desired tire pressure for a particular make and model of vehicle, the RAG component 392 can retrieve—using a RAG model performing a vector search in an embedding space, for example—the tire pressure information or the text corresponding thereto from a digital (embedded) version of the user manual for that particular vehicle make and model. Similarly, where a user revisits a chatbot related to a particular product offering or service, the RAG component 392 can retrieve a prior stored conversation history—or at least a summary thereof—and include the prior conversation history along with the current ask/request as part of the input 301 to the generative LM 330.

The RAG component 392 can use various RAG techniques. For example, naïve RAG can be used where documents are indexed, chunked, and applied to an embedding model to generate embeddings corresponding to the chunks. A user query can also be applied to the embedding model and/or another embedding model of the RAG component 392 and the embeddings of the chunks along with the embeddings of the query can be compared to identify the most similar/related embeddings to the query, which can be supplied to the generative LM 330 to generate an output.

In some implementations, more advanced RAG techniques can be used. For example, prior to passing chunks to the embedding model, the chunks can undergo pre-retrieval processes (e.g., routing, rewriting, metadata analysis, expansion, etc.). In addition, prior to generating the final embeddings, post-retrieval processes (e.g., re-ranking, prompt compression, etc.) can be performed on the outputs of the embedding model prior to final embeddings being used as comparison to an input query.

As a further example, modular RAG techniques can be used, such as those that are similar to naïve and/or advanced RAG, but also include features such as hybrid search, recursive retrieval and query engines, StepBack approaches, sub-queries, and hypothetical document embedding.

As another example, Graph RAG can use knowledge graphs as a source of context or factual information. Graph RAG can be implemented using a graph database as a source of contextual information sent to the LLM/VLM/MMLM/etc. Rather than (or in addition to) providing the model with chunks of data extracted from larger sized documents—which can result in a lack of context, factual correctness, language accuracy, etc.—graph RAG can also provide structured entity information to the LLM/VLM/MMLM/etc. by combining the structured entity textual description with its many properties and relationships, allowing for deeper insights by the model. When implementing graph RAG, the systems and methods described herein use a graph as a content store and extract relevant chunks of documents and ask the LLM/VLM/MMLM/etc. to answer using them. The knowledge graph, in such implementations, can contain relevant textual content and metadata about the knowledge graph as well as be integrated with a vector database. In some implementations, the graph RAG can use a graph as a subject matter expert, where descriptions of concepts and entities relevant to a query/prompt can be extracted and passed to the model as semantic context. These descriptions can include relationships between the concepts. In other examples, the graph can be used as a database, where part of a query/prompt can be mapped to a graph query, the graph query can be executed, and the LLM/VLM/MMLM/etc. can summarize the results. In such an example, the graph can store relevant factual information, and a query (natural language query) to graph query tool (NL-to-Graph-query tool) and entity linking can be used. In some implementations, graph RAG (e.g., using a graph database) can be combined with standard (e.g., vector database) RAG, and/or other RAG types, to benefit from multiple approaches.

In any implementations, the RAG component 392 can implement a plugin, API, user interface, and/or other functionality to perform RAG. For example, a graph RAG plug-in can be used by the LLM/VLM/MMLM/etc. to run queries against the knowledge graph to extract relevant information for feeding to the model, and a standard or vector RAG plug-in can be used to run queries against a vector database. For example, the graph database can interact with a plug-in's REST interface such that the graph database is decoupled from the vector database and/or the embeddings models.

The tokenizer 310 can segment the (e.g., processed) text data into smaller units (tokens) for subsequent analysis and processing. The tokens can represent individual words, subwords, characters, portions of audio/video/image/etc., depending on the implementation. Word-based tokenization divides the text into individual words, treating each word as a separate token. Subword tokenization breaks down words into smaller meaningful units (e.g., prefixes, suffixes, stems), enabling the generative LM 330 to understand morphological variations and handle out-of-vocabulary words more effectively. Character-based tokenization represents each character as a separate token, enabling the generative LM 330 to process text at a fine-grained level. The choice of tokenization strategy can depend on factors such as the language being processed, the task at hand, and/or characteristics of the training dataset. As such, the tokenizer 310 can convert the (e.g., processed) text into a structured format according to tokenization schema being implemented in the particular implementation.

The embedding component 320 can use any known embedding technique to transform discrete tokens into (e.g., dense, continuous vector) representations of semantic meaning. For example, the embedding component 320 can use pre-trained word embeddings (e.g., Word2Vec, GloVe, or FastText), one-hot encoding, Term Frequency-Inverse Document Frequency (TF-IDF) encoding, one or more embedding layers of a neural network, and/or otherwise.

In some implementations in which the input 301 includes image data/video data/etc., the input processor 301 can resize the data to a standard size compatible with format of a corresponding input channel and/or can normalize pixel values to a common range (e.g., 0 to 1) to ensure a consistent representation, and the embedding component 320 can encode the image data using any known technique (e.g., using one or more convolutional neural networks (CNNs) to extract visual features). In some implementations in which the input 301 includes audio data, the input processor 301 can resample an audio file to a consistent sampling rate for uniform processing, and the embedding component 320 can use any known technique to extract and encode audio features—such as in the form of a spectrogram (e.g., a mel-spectrogram). In some implementations in which the input 301 includes video data, the input processor 301 can extract frames or apply resizing to extracted frames, and the embedding component 320 can extract features such as optical flow embeddings or video embeddings and/or can encode temporal information or sequences of frames. In some implementations in which the input 301 includes multi-modal data, the embedding component 320 can fuse representations of the different types of data (e.g., text, image, audio, USD, video, design, etc.) using techniques like early fusion (concatenation), late fusion (sequential processing), attention-based fusion (e.g., self-attention, cross-attention), etc.

The generative LM 330 and/or other components of the generative LM system 300 can use different types of neural network architectures depending on the implementation. For example, transformer-based architectures such as those used in models like GPT can be implemented, and can include self-attention mechanisms that weigh the importance of different words or tokens in the input sequence and/or feedforward networks that process the output of the self-attention layers, applying non-linear transformations to the input representations and extracting higher-level features. Some non-limiting example architectures include transformers (e.g., encoder-decoder, decoder only, multi-modal), RNNs, LSTMs, fusion models, diffusion models, cross-modal embedding models that learn joint embedding spaces, graph neural networks (GNNs), hybrid architectures combining different types of architectures adversarial networks like generative adversarial networks or GANs or adversarial autoencoders (AAEs) for joint distribution learning, and others. As such, depending on the implementation and architecture, the embedding component 320 can apply an encoded representation of the input 301 to the generative LM 330, and the generative LM 330 can process the encoded representation of the input 301 to generate an output 390, which can include responsive text and/or other types of data.

As described herein, in some implementations, the generative LM 330 can be configured to access or use—or capable of accessing or using—plug-ins/APIs 395 (which can include one or more plug-ins, application programming interfaces (APIs), databases, data stores, repositories, etc.). For example, for certain tasks or operations that the generative LM 330 is not ideally suited for, the model can have instructions (e.g., as a result of training, and/or based on instructions in a given prompt, such as those retrieved using the RAG component 392) to access one or more plug-ins/APIs 395 (e.g., 3^{rd} party plugins) for help in processing the current input. In such an example, where at least part of a prompt is related to restaurants or weather, the model can access one or more restaurant or weather plug-ins (e.g., via one or more APIs), send at least a portion of the prompt related to the particular plug-in/API 395 to the plug-in/API 395, the plug-in/API 395 can process the information and return an answer to the generative LM 330, and the generative LM 330 can use the response to generate the output 390. This process can be repeated—e.g., recursively—for any number of iterations and using any number of plug-ins/APIs 395 until an output 390 that addresses each ask/question/request/process/operation/etc. from the input 301 can be generated. As such, the model(s) can not only rely on its own knowledge from training on a large dataset(s) and/or from data retrieved using the RAG component 392, but also on the expertise or optimized nature of one or more external resources—such as the plug-ins/APIs 395.

FIG. 3B is a block diagram of an example implementation in which the generative LM 330 includes a transformer encoder-decoder. Generally, the generative LM 330 can analyze input data to generate queries, identify domain-specific terms, and create embeddings for retrieval and contextual representation tasks. For example, assume input text such as “Who discovered gravity” is tokenized (e.g., by the tokenizer 310 of FIG. 3A) into tokens such as words, and each token is encoded (e.g., by the embedding component 320 of FIG. 3A) into a corresponding embedding (e.g., of size 512). Since these token embeddings typically do not represent the position of the token in the input sequence, any known technique can be used to add a positional encoding to each token embedding to encode the sequential relationships and context of the tokens in the input sequence. As such, the (e.g., resulting) embeddings can be applied to one or more encoder(s) 335 of the generative LM 330.

In an example implementation, the encoder(s) 335 forms an encoder stack, where each encoder includes a self-attention layer and a feedforward network. In an example transformer architecture, each token (e.g., word) flows through a separate path. As such, each encoder can accept a sequence of vectors, passing each vector through the self-attention layer, then the feedforward network, and then upwards to the next encoder in the stack. Any known self-attention technique can be used. For example, to calculate a self-attention score for each token (word), a query vector, a key vector, and a value vector can be created for each token, a self-attention score can be calculated for pairs of tokens by taking the dot product of the query vector with the corresponding key vectors, normalizing the resulting scores, multiplying by corresponding value vectors, and summing weighted value vectors. The encoder can apply multi-headed attention in which the attention mechanism is applied multiple times in parallel with different learned weight matrices. Any number of encoders can be cascaded to generate a context vector encoding the input. An attention projection layer 340 can convert the context vector into attention vectors (keys and values) for the decoder(s) 345.

In an example implementation, the decoder(s) 345 form a decoder stack, where each decoder includes a self-attention layer, an encoder-decoder self-attention layer that uses the attention vectors (keys and values) from the encoder to focus on relevant parts of the input sequence, and a feedforward network. As with the encoder(s) 335, in an example transformer architecture, each token (e.g., word) flows through a separate path in the decoder(s) 345. During a first pass, the decoder(s) 345, a classifier 350, and a generation mechanism 355 can generate a first token, and the generation mechanism 355 can apply the generated token as an input during a second pass. The process can repeat in a loop, successively generating and adding tokens (e.g., words) to the output from the preceding pass and applying the token embeddings of the composite sequence with positional encodings as an input to the decoder(s) 345 during a subsequent pass, sequentially generating one token at a time (known as auto-regression) until predicting a symbol or token that represents the end of the response. Within each decoder, the self-attention layer is typically constrained to attend only to preceding positions in the output sequence by applying a masking technique (e.g., setting future positions to negative infinity) before the softmax operation. In an example implementation, the encoder-decoder attention layer operates similarly to the (e.g., multi-headed) self-attention in the encoder(s) 335, except that it creates its queries from the layer below it and takes the keys and values (e.g., matrix) from the output of the encoder(s) 335.

As such, the decoder(s) 345 can output some decoded (e.g., vector) representation of the input being applied during a particular pass. The classifier 350 can include a multi-class classifier comprising one or more neural network layers that project the decoded (e.g., vector) representation into a corresponding dimensionality (e.g., one dimension for each supported word or token in the output vocabulary) and a softmax operation that converts logits to probabilities. As such, the generation mechanism 355 can select or sample a word or token based on a corresponding predicted probability (e.g., select the word with the highest predicted probability) and append it to the output from a previous pass, generating each word or token sequentially. The generation mechanism 355 can repeat the process, triggering successive decoder inputs and corresponding predictions until selecting or sampling a symbol or token that represents the end of the response, at which point, the generation mechanism 355 can output the generated response.

FIG. 3C is a block diagram of an example implementation in which the generative LM 330 includes a decoder-only transformer architecture. For example, the decoder(s) 360 of FIG. 3C can operate similarly as the decoder(s) 345 of FIG. 3B except each of the decoder(s) 360 of FIG. 3C omits the encoder-decoder self-attention layer (since there is no encoder in this implementation). As such, the decoder(s) 360 can form a decoder stack, where each decoder includes a self-attention layer and a feedforward network. Furthermore, instead of encoding the input sequence, a symbol or token representing the end of the input sequence (or the beginning of the output sequence) can be appended to the input sequence, and the resulting sequence (e.g., corresponding embeddings with positional encodings) can be applied to the decoder(s) 360. As with the decoder(s) 345 of FIG. 3B, each token (e.g., word) can flow through a separate path in the decoder(s) 360, and the decoder(s) 360, a classifier 365, and a generation mechanism 370 can use auto-regression to sequentially generate one token at a time until predicting a symbol or token that represents the end of the response. The classifier 365 and the generation mechanism 370 can operate similarly as the classifier 350 and the generation mechanism 355 of FIG. 3B, with the generation mechanism 370 selecting or sampling each successive output token based on a corresponding predicted probability and appending it to the output from a previous pass, generating each token sequentially until selecting or sampling a symbol or token that represents the end of the response. These and other architectures described herein are meant simply as examples, and other suitable architectures can be implemented within the scope of the present disclosure.

### Example Computing Device

FIG. 4 is a block diagram of an example computing device(s) 400 suitable for use in implementing some implementations of the present disclosure. Generally, the example computing device(s) 400 can execute processes to handle input data, perform tokenization, generate embeddings, and manage retrieval operations for data processing tasks. Computing device 400 can include an interconnect system 402 that directly or indirectly couples the following devices: memory 404, one or more central processing units (CPUs) 406, one or more graphics processing units (GPUs) 408, a communication interface 410, input/output (I/O) ports 412, input/output components 414, a power supply 416, one or more presentation components 418 (e.g., display(s)), and one or more logic units 420. In at least one implementation, the computing device(s) 400 can comprise one or more virtual machines (VMs), and/or any of the components thereof can comprise virtual components (e.g., virtual hardware components). For non-limiting examples, one or more of the GPUs 408 can comprise one or more vGPUs, one or more of the CPUs 406 can comprise one or more vCPUs, and/or one or more of the logic units 420 can comprise one or more virtual logic units. As such, a computing device(s) 400 can include discrete components (e.g., a full GPU dedicated to the computing device 400), virtual components (e.g., a portion of a GPU dedicated to the computing device 400), or a combination thereof.

Although the various blocks of FIG. 4 are shown as connected via the interconnect system 402 with lines, this is not intended to be limiting and is for clarity only. For example, in some implementations, a presentation component 418, such as a display device, can be considered an I/O component 414 (e.g., if the display is a touch screen). As another example, the CPUs 406 and/or GPUs 408 can include memory (e.g., the memory 404 can be representative of a storage device in addition to the memory of the GPUs 408, the CPUs 406, and/or other components). As such, the computing device of FIG. 4 is merely illustrative. Distinction is not made between such categories as “workstation,” “server,” “laptop,” “desktop,” “tablet,” “client device,” “mobile device,” “hand-held device,” “game console,” “electronic control unit (ECU),” “virtual reality system,” and/or other device or system types, as all are contemplated within the scope of the computing device of FIG. 4.

The interconnect system 402 can represent one or more links or busses, such as an address bus, a data bus, a control bus, or a combination thereof. The interconnect system 402 can include one or more bus or link types, such as an industry standard architecture (ISA) bus, an extended industry standard architecture (EISA) bus, a video electronics standards association (VESA) bus, a peripheral component interconnect (PCI) bus, a peripheral component interconnect express (PCIe) bus, and/or another type of bus or link. In some implementations, there are direct connections between components. As an example, the CPU 406 can be directly connected to the memory 404. Further, the CPU 406 can be directly connected to the GPU 408. Where there is direct, or point-to-point connection between components, the interconnect system 402 can include a PCIe link to carry out the connection. In these examples, a PCI bus need not be included in the computing device 400.

The memory 404 can include any of a variety of computer-readable media. The computer-readable media can be any available media that can be accessed by the computing device 400. The computer-readable media can include both volatile and nonvolatile media, and removable and non-removable media. By way of example, and not limitation, the computer-readable media can comprise computer-storage media and communication media.

The computer-storage media can include both volatile and nonvolatile media and/or removable and non-removable media implemented in any method or technology for storage of information such as computer-readable instructions, data structures, program modules, and/or other data types. For example, the memory 404 can store computer-readable instructions (e.g., that represent a program(s) and/or a program element(s), such as an operating system. Computer-storage media can include, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computing device 400. As used herein, computer storage media does not comprise signals per se.

The computer storage media can embody computer-readable instructions, data structures, program modules, and/or other data types in a modulated data signal such as a carrier wave or other transport mechanism and includes any information delivery media. The term “modulated data signal” can refer to a signal that has one or more of its characteristics set or changed in such a manner as to encode information in the signal. By way of example, and not limitation, the computer storage media can include wired media such as a wired network or direct-wired connection, and wireless media such as acoustic, RF, infrared and other wireless media. Combinations of any of the above should also be included within the scope of computer-readable media.

The CPU(s) 406 can be configured to execute at least some of the computer-readable instructions to control one or more components of the computing device 400 to perform one or more of the methods and/or processes described herein. The CPU(s) 406 can each include one or more cores (e.g., one, two, four, eight, twenty-eight, seventy-two, etc.) that are capable of handling a multitude of software threads simultaneously. The CPU(s) 406 can include any type of processor, and can include different types of processors depending on the type of computing device 400 implemented (e.g., processors with fewer cores for mobile devices and processors with more cores for servers). For example, depending on the type of computing device 400, the processor can be an Advanced RISC Machines (ARM) processor implemented using Reduced Instruction Set Computing (RISC) or an x86 processor implemented using Complex Instruction Set Computing (CISC). The computing device 400 can include one or more CPUs 406 in addition to one or more microprocessors or supplementary co-processors, such as math co-processors.

In addition to or alternatively from the CPU(s) 406, the GPU(s) 408 can be configured to execute at least some of the computer-readable instructions to control one or more components of the computing device 400 to perform one or more of the methods and/or processes described herein. One or more of the GPU(s) 408 can be an integrated GPU (e.g., with one or more of the CPU(s) 406 and/or one or more of the GPU(s) 408 can be a discrete GPU. In implementations, one or more of the GPU(s) 408 can be a coprocessor of one or more of the CPU(s) 406. The GPU(s) 408 can be used by the computing device 400 to render graphics (e.g., 3D graphics) or perform general purpose computations. For example, the GPU(s) 408 can be used for General-Purpose computing on GPUs (GPGPU). The GPU(s) 408 can include hundreds or thousands of cores that are capable of handling hundreds or thousands of software threads simultaneously. The GPU(s) 408 can generate pixel data for output images in response to rendering commands (e.g., rendering commands from the CPU(s) 406 received via a host interface). The GPU(s) 408 can include graphics memory, such as display memory, for storing pixel data or any other suitable data, such as GPGPU data. The display memory can be included as part of the memory 404. The GPU(s) 408 can include two or more GPUs operating in parallel (e.g., via a link). The link can directly connect the GPUs (e.g., using NVLINK) or can connect the GPUs through a switch (e.g., using NVSwitch). When combined together, each GPU 408 can generate pixel data or GPGPU data for different portions of an output or for different outputs (e.g., a first GPU for a first image and a second GPU for a second image). Each GPU can include its own memory, or can share memory with other GPUs.

In addition to or alternatively from the CPU(s) 406 and/or the GPU(s) 408, the logic unit(s) 420 can be configured to execute at least some of the computer-readable instructions to control one or more components of the computing device 400 to perform one or more of the methods and/or processes described herein. In implementations, the CPU(s) 406, the GPU(s) 408, and/or the logic unit(s) 420 can discretely or jointly perform any combination of the methods, processes and/or portions thereof. One or more of the logic units 420 can be part of and/or integrated in one or more of the CPU(s) 406 and/or the GPU(s) 408 and/or one or more of the logic units 420 can be discrete components or otherwise external to the CPU(s) 406 and/or the GPU(s) 408. In implementations, one or more of the logic units 420 can be a coprocessor of one or more of the CPU(s) 406 and/or one or more of the GPU(s) 408.

Examples of the logic unit(s) 420 include one or more processing cores and/or components thereof, such as Data Processing Units (DPUs), Tensor Cores (TCs), Tensor Processing Units (TPUs), Pixel Visual Cores (PVCs), Vision Processing Units (VPUs), Graphics Processing Clusters (GPCs), Texture Processing Clusters (TPCs), Streaming Multiprocessors (SMs), Tree Traversal Units (TTUs), Artificial Intelligence Accelerators (AIAs), Deep Learning Accelerators (DLAs), Programmable Vision Accelerator (PVAs)—which can include one or more direct memory access (DMA) systems, one or more vision or vector processing units (VPUs), one or more pixel processing engines (PPEs)—e.g., including a 2D array of processing elements that each communicate north, south, east, and west with one or more other processing elements in the array, one or more decoupled accelerators or units (e.g., decoupled lookup table (DLUT) accelerators or units), etc., Vision Processing Units (VPUs), Optical Flow Accelerators (OFAs), Field Programmable Gate Arrays (FPGAs), Neuromorphic Chips, Quantum Processing Units (QPUs), Associative Process Units (APUs), Arithmetic-Logic Units (ALUs), Application-Specific Integrated Circuits (ASICs), Floating Point Units (FPUs), input/output (I/O) elements, peripheral component interconnect (PCI) or peripheral component interconnect express (PCIe) elements, and/or the like.

The communication interface 410 can include one or more receivers, transmitters, and/or transceivers that allow the computing device 400 to communicate with other computing devices via an electronic communication network, included wired and/or wireless communications. The communication interface 410 can include components and functionality to allow communication over any of a number of different networks, such as wireless networks (e.g., Wi-Fi, Z-Wave, Bluetooth, Bluetooth LE, ZigBee, etc.), wired networks (e.g., communicating over Ethernet or InfiniBand), low-power wide-area networks (e.g., LoRaWAN, SigFox, etc.), and/or the Internet. In one or more implementations, logic unit(s) 420 and/or communication interface 410 can include one or more data processing units (DPUs) to transmit data received over a network and/or through interconnect system 402 directly to (e.g., a memory of) one or more GPU(s) 408.

The I/O ports 412 can allow the computing device 400 to be logically coupled to other devices including the I/O components 414, the presentation component(s) 418, and/or other components, some of which can be built in to (e.g., integrated in) the computing device 400. Illustrative I/O components 414 include a microphone, mouse, keyboard, joystick, game pad, game controller, satellite dish, scanner, printer, wireless device, etc. The I/O components 414 can provide a natural user interface (NUI) that processes air gestures, voice, or other physiological inputs generated by a user. In some instances, inputs can be transmitted to an appropriate network element for further processing. An NUI can implement any combination of speech recognition, stylus recognition, facial recognition, biometric recognition, gesture recognition both on screen and adjacent to the screen, air gestures, head and eye tracking, and touch recognition (as described in more detail below) associated with a display of the computing device 400. The computing device 400 can be include depth cameras, such as stereoscopic camera systems, infrared camera systems, RGB camera systems, touchscreen technology, and combinations of these, for gesture detection and recognition. Additionally, the computing device 400 can include accelerometers or gyroscopes (e.g., as part of an inertia measurement unit (IMU)) that allow detection of motion. In some examples, the output of the accelerometers or gyroscopes can be used by the computing device 400 to render immersive augmented reality or virtual reality.

The power supply 416 can include a hard-wired power supply, a battery power supply, or a combination thereof. The power supply 416 can provide power to the computing device 400 to allow the components of the computing device 400 to operate.

The presentation component(s) 418 can include a display (e.g., a monitor, a touch screen, a television screen, a heads-up-display (HUD), other display types, or a combination thereof), speakers, and/or other presentation components. The presentation component(s) 418 can receive data from other components (e.g., the GPU(s) 408, the CPU(s) 406, DPUs, etc.), and output the data (e.g., as an image, video, sound, etc.).

### Example Data Center

FIG. 5 illustrates an example data center 500 that can be used in at least one implementations of the present disclosure. Generally, the example data center 500 can support large-scale data processing, manage distributed storage, and execute models for tokenization, embedding generation, and retrieval tasks. The data center 500 can include a data center infrastructure layer 510, a framework layer 520, a software layer 530, and/or an application layer 540.

As shown in FIG. 5, the data center infrastructure layer 510 can include a resource orchestrator 512, grouped computing resources 514, and node computing resources (“node C.R.s”) 516(1)-516(N), where “N” represents any whole, positive integer. In at least one implementation, node C.R.s 516(1)-516(N) can include, but are not limited to, any number of central processing units (CPUs) or other processors (including DPUs, accelerators, field programmable gate arrays (FPGAs), graphics processors or graphics processing units (GPUs), etc.), memory devices (e.g., dynamic read-only memory), storage devices (e.g., solid state or disk drives), network input/output (NW I/O) devices, network switches, virtual machines (VMs), power modules, and/or cooling modules, etc. In some implementations, one or more node C.R.s from among node C.R.s 516(1)-516(N) can correspond to a server having one or more of the above-mentioned computing resources. In addition, in some implementations, the node C.R.s 516(1)-5161(N) can include one or more virtual components, such as vGPUs, vCPUs, and/or the like, and/or one or more of the node C.R.s 516(1)-516(N) can correspond to a virtual machine (VM).

In at least one implementation, grouped computing resources 514 can include separate groupings of node C.R.s 516 housed within one or more racks (not shown), or many racks housed in data centers at various geographical locations (also not shown). Separate groupings of node C.R.s 516 within grouped computing resources 514 can include grouped compute, network, memory or storage resources that can be configured or allocated to support one or more workloads. In at least one implementation, several node C.R.s 516 including CPUs, GPUs, DPUs, and/or other processors can be grouped within one or more racks to provide compute resources to support one or more workloads. The one or more racks can also include any number of power modules, cooling modules, and/or network switches, in any combination.

The resource orchestrator 512 can configure or otherwise control one or more node C.R.s 516(1)-516(N) and/or grouped computing resources 514. In at least one implementation, resource orchestrator 512 can include a software design infrastructure (SDI) management entity for the data center 500. The resource orchestrator 512 can include hardware, software, or some combination thereof.

In at least one implementation, as shown in FIG. 5, framework layer 520 can include a job scheduler 528, a configuration manager 534, a resource manager 536, and/or a distributed file system 538. The framework layer 520 can include a framework to support software 532 of software layer 530 and/or one or more application(s) 542 of application layer 540. The software 532 or application(s) 542 can respectively include web-based service software or applications, such as those provided by Amazon Web Services, Google Cloud and Microsoft Azure. The framework layer 520 can be, but is not limited to, a type of free and open-source software web application framework such as Apache Spark™ (hereinafter “Spark”) that can use distributed file system 538 for large-scale data processing (e.g., “big data”). In at least one implementation, job scheduler 528 can include a Spark driver to facilitate scheduling of workloads supported by various layers of data center 500. The configuration manager 534 can be capable of configuring different layers such as software layer 530 and framework layer 520 including Spark and distributed file system 538 for supporting large-scale data processing. The resource manager 536 can be capable of managing clustered or grouped computing resources mapped to or allocated for support of distributed file system 538 and job scheduler 528. In at least one implementation, clustered or grouped computing resources can include grouped computing resource 514 at data center infrastructure layer 510. The resource manager 536 can coordinate with resource orchestrator 512 to manage these mapped or allocated computing resources.

In at least one implementation, software 532 included in software layer 530 can include software used by at least portions of node C.R.s 516(1)-516(N), grouped computing resources 514, and/or distributed file system 538 of framework layer 520. One or more types of software can include, but are not limited to, Internet web page search software, e-mail virus scan software, database software, and streaming video content software.

In at least one implementation, application(s) 542 included in application layer 540 can include one or more types of applications used by at least portions of node C.R.s 516(1)-516(N), grouped computing resources 514, and/or distributed file system 538 of framework layer 520. One or more types of applications can include, but are not limited to, any number of a genomics application, a cognitive compute, and a machine learning application, including training or inferencing software, machine learning framework software (e.g., PyTorch, TensorFlow, Caffe, etc.), and/or other machine learning applications used in conjunction with one or more implementations.

In at least one implementation, any of configuration manager 534, resource manager 536, and resource orchestrator 512 can implement any number and type of self-modifying actions based on any amount and type of data acquired in any technically feasible fashion. Self-modifying actions can relieve a data center operator of data center 500 from making possibly bad configuration decisions and possibly avoiding underutilized and/or poor performing portions of a data center.

The data center 500 can include tools, services, software or other resources to train one or more machine learning models or predict or infer information using one or more machine learning models according to one or more implementations described herein. For example, a machine learning model(s) can be trained by calculating weight parameters according to a neural network architecture using software and/or computing resources described above with respect to the data center 500. In at least one implementation, trained or deployed machine learning models corresponding to one or more neural networks can be used to infer or predict information using resources described above with respect to the data center 500 by using weight parameters calculated through one or more training techniques, such as but not limited to those described herein.

In at least one implementation, the data center 500 can use CPUs, application-specific integrated circuits (ASICs), GPUs, FPGAs, and/or other hardware (or virtual compute resources corresponding thereto) to perform training and/or inferencing using above-described resources. Moreover, one or more software and/or hardware resources described above can be configured as a service to allow users to train or performing inferencing of information, such as image recognition, speech recognition, or other artificial intelligence services.

### Example Network Environments

Network environments suitable for use in implementing implementations of the disclosure can include one or more client devices, servers, network attached storage (NAS), other backend devices, and/or other device types. The client devices, servers, and/or other device types (e.g., each device) can be implemented on one or more instances of the computing device(s) 400 of FIG. 4—e.g., each device can include similar components, features, and/or functionality of the computing device(s) 400. In addition, where backend devices (e.g., servers, NAS, etc.) are implemented, the backend devices can be included as part of a data center 500, an example of which is described in more detail herein with respect to FIG. 5.

Components of a network environment can communicate with each other via a network(s), which can be wired, wireless, or both. The network can include multiple networks, or a network of networks. By way of example, the network can include one or more Wide Area Networks (WANs), one or more Local Area Networks (LANs), one or more public networks such as the Internet and/or a public switched telephone network (PSTN), and/or one or more private networks. Where the network includes a wireless telecommunications network, components such as a base station, a communications tower, or even access points (as well as other components) can provide wireless connectivity.

Compatible network environments can include one or more peer-to-peer network environments—in which case a server cannot be included in a network environment—and one or more client-server network environments—in which case one or more servers can be included in a network environment. In peer-to-peer network environments, functionality described herein with respect to a server(s) can be implemented on any number of client devices.

In at least one implementation, a network environment can include one or more cloud-based network environments, a distributed computing environment, a combination thereof, etc. A cloud-based network environment can include a framework layer, a job scheduler, a resource manager, and a distributed file system implemented on one or more of servers, which can include one or more core network servers and/or edge servers. A framework layer can include a framework to support software of a software layer and/or one or more application(s) of an application layer. The software or application(s) can respectively include web-based service software or applications. In implementations, one or more of the client devices can use the web-based service software or applications (e.g., by accessing the service software and/or applications via one or more application programming interfaces (APIs)). The framework layer can be, but is not limited to, a type of free and open-source software web application framework such as that can use a distributed file system for large-scale data processing (e.g., “big data”).

A cloud-based network environment can provide cloud computing and/or cloud storage that carries out any combination of computing and/or data storage functions described herein (or one or more portions thereof). Any of these various functions can be distributed over multiple locations from central or core servers (e.g., of one or more data centers that can be distributed across a state, a region, a country, the globe, etc.). If a connection to a user (e.g., a client device) is relatively close to an edge server(s), a core server(s) can designate at least a portion of the functionality to the edge server(s). A cloud-based network environment can be private (e.g., limited to a single organization), can be public (e.g., available to many organizations), and/or a combination thereof (e.g., a hybrid cloud environment).

The client device(s) can include at least some of the components, features, and functionality of the example computing device(s) 400 described herein with respect to FIG. 4. By way of example and not limitation, a client device can be embodied as a Personal Computer (PC), a laptop computer, a mobile device, a smartphone, a tablet computer, a smart watch, a wearable computer, a Personal Digital Assistant (PDA), an MP3 player, a virtual reality headset, a Global Positioning System (GPS) or device, a video player, a video camera, a surveillance device or system, a vehicle, a boat, a flying vessel, a virtual machine, a drone, a robot, a handheld communications device, a hospital device, a gaming device or system, an entertainment system, a vehicle computer system, an embedded system controller, a remote control, an appliance, a consumer electronic device, a workstation, an edge device, any combination of these delineated devices, or any other suitable device.

The disclosure can be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The disclosure can be practiced in a variety of system configurations, including hand-held devices, consumer electronics, general-purpose computers, more specialty computing devices, etc. The disclosure can also be practiced in distributed computing environments where tasks are performed by remote-processing devices that are linked through a communications network.

As used herein, a recitation of “and/or” with respect to two or more elements should be interpreted to mean only one element, or a combination of elements. For example, “element A, element B, and/or element C” can include only element A, only element B, only element C, element A and element B, element A and element C, element B and element C, or elements A, B, and C. In addition, “at least one of element A or element B” can include at least one of element A, at least one of element B, or at least one of element A and at least one of element B. Further, “at least one of element A and element B” can include at least one of element A, at least one of element B, or at least one of element A and at least one of element B.

The subject matter of the present disclosure is described with specificity herein to meet statutory requirements. However, the description itself is not intended to limit the scope of this disclosure. Rather, the inventors have contemplated that the claimed subject matter might also be embodied in other ways, to include different steps or combinations of steps similar to the ones described in this document, in conjunction with other present or future technologies. Moreover, although the terms “step” and/or “block” can be used herein to connote different elements of methods employed, the terms should not be interpreted as implying any particular order among or between various steps herein disclosed unless and except when the order of individual steps is explicitly described.

What is claimed is:

1. One or more processors comprising processing circuitry to:
input, to a tokenizer, one or more terms that satisfy a uniqueness criterion to cause the tokenizer to tokenize the one or more terms into a vocabulary dataset, the one or more terms corresponding with a domain and extracted from a plurality of documents;
extract, from the plurality of documents, a plurality of portions of the plurality of documents comprising the one or more terms corresponding with the domain;
generate, based at least on the plurality of portions, a plurality of queries corresponding to the plurality of portions; and
update an embedding model based at least on the plurality of queries, the plurality of portions, and the vocabulary dataset.

2. The one or more processors of claim 1, wherein the plurality of portions of the plurality of documents are extracted by segmenting the plurality of documents based on at least one marker to segment content of the plurality of documents into the plurality of portions.

3. The one or more processors of claim 1, wherein the plurality of queries corresponding to the plurality of portions are generated by a large language model (LLM) trained to generate the plurality of queries based on content and context of the extracted plurality of portions.

4. The one or more processors of claim 3, wherein the content comprises textual information in the plurality of portions, and wherein the context comprises an association of the plurality of queries with the plurality of portions.

5. The one or more processors of claim 3, wherein the generation of the plurality of queries comprises prompting the LLM with a plurality of instructions based on the content and context of the plurality of portions and corresponding with at least one parameter.

6. The one or more processors of claim 1, wherein the one or more terms of the plurality of documents are extracted by an LLM trained to identify a plurality of segments of data based on the uniqueness criterion.

7. The one or more processors of claim 6, wherein the extraction of the one or more terms comprises prompting the LLM with a plurality of instructions to identify a plurality of terms in the plurality of documents and corresponding with the uniqueness criterion.

8. The one or more processors of claim 1, wherein the uniqueness criterion comprises a plurality of frequencies of the one or more terms being below a threshold frequency in a vocabulary of the tokenizer.

9. The one or more processors of claim 8, wherein the threshold frequency corresponds to a frequency of occurrence or a frequency of co-occurrence, and wherein the threshold frequency is set based on a plurality of occurrences of a plurality of domain-specific terms within the plurality of documents.

10. The one or more processors of claim 1, wherein the embedding model comprises a transformer model trained to convert a plurality of textual inputs into a plurality of continuous vector representations based on processing a plurality of tokens through a plurality of multi-layer attention mechanisms to encode a plurality of semantic relationships between the one or more terms.

11. The one or more processors of claim 1, wherein the one or more processors are comprised in at least one of:
a system implementing one or more large language models (LLMs);
a system implementing one or more small language models (SLMs);
a system implementing one or more vision language models (VLMs);
a system for generating synthetic data;
a system for generating synthetic data using AI;
a control system for an autonomous or semi-autonomous machine;
a perception system for an autonomous or semi-autonomous machine;
a system for performing simulation operations;
a system for performing digital twin operations;
a system for performing light transport simulation;
a system for performing collaborative content creation for 3D assets;
a system for performing deep learning operations;
a system for performing remote operations;
a system for performing real-time streaming;
a system for generating or presenting one or more of augmented reality content, virtual reality content, or mixed reality content;
a system implemented using an edge device;
a system implemented using a robot;
a system for performing conversational AI operations;
a system implementing one or more multi-model language models;
a system incorporating one or more virtual machines (VMs);
a system implemented at least partially in a data center; or
a system implemented at least partially using cloud computing resources.

12. A system comprising:
one or more processors to execute operations comprising:
extract, from a plurality of documents, a plurality of portions of the plurality of documents comprising one or more terms corresponding with a domain;
generate, based at least on the plurality of portions, a plurality of queries corresponding to the plurality of portions;
input, to a tokenizer, the one or more terms that satisfy a uniqueness criterion to cause the tokenizer to tokenize the one or more terms into a vocabulary dataset, the one or more terms extracted from the plurality of documents; and
update an embedding model based at least on the plurality of queries, the plurality of portions, and the vocabulary dataset.

13. The system of claim 12, wherein the plurality of portions of the plurality of documents are extracted by segmenting the plurality of documents based on at least one marker to segment content of the plurality of documents into the plurality of portions.

14. The system of claim 12, wherein the plurality of queries corresponding to the plurality of portions are generated by an large language model (LLM) trained to generate the plurality of queries based on content and context of the extracted plurality of portions.

15. The system of claim 14, wherein the content comprises textual information in the plurality of portions, and wherein the context comprises an association of the plurality of queries with the plurality of portions.

16. The system of claim 14, wherein the generation of the plurality of queries comprises prompting the LLM with a plurality of instructions based on the content and context of the plurality of portions and corresponding with at least one parameter.

17. The system of claim 12, wherein the one or more terms of the plurality of documents are extracted by an LLM trained to identify a plurality of segments of data based on the uniqueness criterion.

18. The system of claim 17, wherein the extraction of the one or more terms comprises prompting the LLM with a plurality of instructions to identify a plurality of terms in the plurality of documents and corresponding with the uniqueness criterion.

19. The system of claim 12, wherein the uniqueness criterion comprises a plurality of frequencies of the one or more terms being below a threshold frequency in a vocabulary of the tokenizer.

20. A method, comprising:
inputting, using one or more processors, one or more terms that satisfy a uniqueness criterion to cause the one or more processors to tokenize the one or more terms into a vocabulary dataset, the one or more terms corresponding with a domain and extracted from a plurality of documents;
extracting, using the one or more processors from the plurality of documents, a plurality of portions of the plurality of documents comprising one or more terms corresponding with a domain;
generating, using the one or more processors based at least on the plurality of portions, a plurality of queries corresponding to the plurality of portions; and
updating, using the one or more processors, an embedding model based at least on the plurality of queries, the plurality of portions, and the vocabulary dataset.
